(19) United States
(12) Patent Application Publication
(10) Pub. No.: US 2026/0118536 A1
(43) Pub. Date: Apr. 30, 2026

(54) MODELING METHOD FOR IDENTIFYING NATURAL FRACTURE USING GRADING AND CLASSIFICATION QUANTITATIVE IDENTIFIER

(71) Applicant: Southwest Petroleum University, Chengdu City (CN)

(72) Inventors: Chenghua OU, Chengdu City (CN); Peipei GUO, Chengdu City (CN); Chaochun LI, Chengdu City (CN)

(21) Appl. No.: 18/925,291

(22) Filed: Oct. 24, 2024

(51) Int. Cl. G01V 1/30; G01V 1/28; G01V 1/50

(52) U.S. Cl. CPC G01V 1/301; G01V 1/282; G01V 1/50; G01V 2210/646; G01V 2210/665

(57) ABSTRACT

A modeling method for identifying a natural fracture using a grading and classification quantitative identifier is provided. The method includes constructing a wellbore natural fracture grading and classification quantitative identifier by means of the fusion of static and dynamic information and macroscopic and microscopic information. A spatial natural fracture grading and classification quantitative identifier is constructed by means of seismic attribute multi-level nested variable time window optimization, and completing accurate, reliable and rapid construction of a grading and classification three-dimensional network model of natural fractures using an identification result above and a grading and classification three-dimensional modeling method of natural fractures.

### TECHNICAL FIELD

The present disclosure relates to the technical field of geology, and in particular to a modeling method for identifying a natural fracture using a grading and classification quantitative identifier.

### BACKGROUND

According to the latest monthly short-term energy outlook report released by the Energy Information Administration (EIA), in 2024, the world oil demand will reach 103.1 million barrels per day, which increases in comparison with the previous forecast of 102.9 million barrels per day. The world oil demand is expected to further increase to 104.6 million barrels per day by 2025. Nowadays, renewable energy/alternative energy is increasingly valued, but its popularization still takes some time, and the proportion of oil in the global energy structure is still relatively large, which means that the demand for oil remains strong in the short term. The oil reserves of conventional fractured reservoirs account for more than 70% of the new oil reserves in the world, and their reserves and production account for about half of the world. More than fifty oil-gas fields have been discovered in the Zagros piedmont zone of the Persian Gulf Basin, of which more than twenty are fractured oil-gas reservoirs, and six giant oil-gas fields with reserves of more than 1 billion tons exist. Fractures in Ainzaleh oilfield in Iraq are also well developed. Fractured oil-gas reservoirs have been found in Bohai Bay Basin, Songliao Basin, Sichuan Basin, Qaidam Basin and Jiuxi Basin in the west of China, and have formed industrial productivity. For unconventional oil-gas reservoirs such as tight sandstone, tight carbonate rocks and shale oil-gas, fracturing is required for production increase, but the implementation and output effect of fracturing are greatly affected by natural fractures. Due to complex distribution and unclear mechanism of natural fractures, artificial fractures may propagate only in the direction of the natural fractures, making it difficult to form an effective fracture network, and engineering phenomena such as pressure channeling and wellbore deformation may also be caused. Therefore, it is a key step to achieve efficient development of oil reservoirs by accurately and reliably characterizing the distribution pattern of natural fractures in the three-dimensional space and establishing a three-dimensional quantitative network model.

The distribution of the natural fractures is complex, which is not only controlled by primary geological factors, but also affected by multi-level tectonic stress, resulting in the development of induced fractures near faults and natural fractures in structurally stable zones far away from the faults. For different oil-gas reservoirs and research data, the three-dimensional fine characterization of the natural fracture mainly has the following problems. (1) There are few constraint data about single well fractures, and the number of cores obtained is limited, leading to difficulty in achieving coring in the whole well section and whole working area. Imaging logging is expensive, making it almost impossible to achieve the logging of every well. The characterization is easily affected by uncontrollable factors such as borehole wall, mud, contact between a polar plate and formation, and the experience of interpreters. Although artificial intelligence provides a way to identify the development of the single well fracture, the reliability of this method depends on the reliability and richness of samples. (2) The geological process is complex and changeable, and the main controlling factors of the development of the natural fractures are diverse, which leads to complex distribution of the natural fractures, and difficulty to achieve a method for characterizing the spatial distribution law of natural fractures. (3) The fractures in different directions have different degrees of development, underground opening degree and connectivity degree of the fractures in different systems are also different, which leads to a great difference in permeability of the fractures in different directions and aggravates the heterogeneity of reservoirs, and is prone to short water breakthrough time, rapid decline in injection pressure, rapid decline in initial production and great difference in production of adjacent wells. (4) Some natural fractures are directly induced by faults, and the information of fractures within a certain distance near the faults can be extracted for modeling. However, in the structurally stable zones far away from faults, local stress concentration will also lead to fracture development, so this method is not applicable. (5) The earthquake prediction is used to establish a three-dimensional model of the natural fracture, which has the problem of the resolution of the seismic data. Moreover, the reliability of the earthquake prediction model has not been verified by geological data such as cores and logging. Therefore, combined with the actual situation, how to make full use of the existing data to form a complete and unified technical process by ensuring the richness of the geological constraint data and the high resolution of the cross-well fracture prediction seismic data and fully integrating the existing information for mutual verification to achieve fine description of the spatial distribution characteristics of natural fractures in the fault development zones and structurally stable zones has become a technical problem to be solved.

Granted invention patent “Modeling method for natural fracture in tight sandstone reservoir” (filed on Aug. 9, 2019, inventors: Li Hui, Lin Chengyan, Ren Lihua, Li Shitao, Chen Yanyan; Patent No. CN201910732445.1) provides a modeling method for a natural fracture in a tight sandstone reservoir. Granted invention patent “Multi-scale fracture modeling method” (filed on May 18, 2012, inventors: Zhang Jinliang, Tang Mingming, Ren Weiwei; Patent No. CN201210154441.8) provides a multi-scale fracture modeling method. However, all the above methods require rock mechanics research, mechanical parameters are difficult to obtain, stress field models need to be adjusted repeatedly, and the requirements for computer performance are high.

Granted invention patent “Discrete fracture modeling method based on multi-point geostatistics” (filed on Mar. 27, 2019, inventors: Liu Yanfeng, Zhang Wenbiao, Lian Peiqing, Shang Xiaofei, Wang Mingchuan, Zhao Lei, Zhao Huawei, Li Meng; Patent No. CN201910238530.2) provides a discrete fracture modeling method based on multi-point geostatistics, which is used to characterize a spatial configuration relationship between fractures with different scales. Granted invention patent “3D modeling method for fracture in reservior” (filed on Aug. 4, 2017, inventors: Zhao Xiangyuan, Hu Xiangyang, Zhang Wenbiao; Patent No. CN201710665503.4) provides a three-dimensional modeling method for a fracture in a reservoir. In such methods, multi-point geostatistics are used to achieve cross-well fracture prediction, a stratum three-dimensional fracture development model is established based on the geological constraints of fractures in multiple single wells. However, these methods are too random for blocks with few wells, which may cause a big difference from the actual geological situation.

Granted invention patent “Discrete fracture modeling method based on multi-scale factor constraint” (filed on Jan. 25, 2015, inventor: Feng Jianwei; Gao Changhai; Patent No. CN201510036574.9) provides a discrete fracture modeling method based on a multi-scale factor constraint. This method includes establishing discrete models of fractures with various scales by selecting the main geological factors of the development of the fractures by using an entropy weight method. However, this method considers the constraints of geological factors more, and obviously cannot reasonably characterize the cross-well fractures and the fractures in the blocks without wells.

In the article “Study on the automatic recognition of fault system and fracture modeling in Dawan Area of Puguang Gasfield” (published in June 2013; Authors: Wang Lezhi, Liu Honglei, Zhang Jixi, etc.), a fracture network model is established using automatic analysis technology of fault system and the modeling technology of discrete fracture network. However, the reliability of this method is based on relatively complete single well fracture data.

Granted invention patent “Quantitative fracture prediction method and device based on post-stack seismic data” (filed on Apr. 17, 2020, inventors: Yu Hao, Fan Xinran, Huang Jiaqiang, Lan Xuemei, Zhang Lianjin, Zhang Xuan, Liu Junying; Patent No. CN202010303762.4) provides a quantitative fracture prediction method and device based on post-stack seismic data, which can achieve quantitative fracture prediction based on post-stack seismic data. This method improves the fracture prediction accuracy, but has the problem of multiple solutions.

Granted invention patent “Prediction method of plane distribution law of effective natural fracture in oil reservoir” (filed on Mar. 21, 2012, inventors: Fan Jianming, Zhao Jiyong, He Yonghong, Li Shuheng, Zeng Lianbo, Wang Jie, Chen Wenlong, Yang Junxia; Patent No. CN201210076667.0) provides a prediction method of plane distribution law of effective natural fractures in an oil reservoir. The plane distribution law of the effective natural fractures is obtained through conventional fracture identification and finite element method, but this method does not form a three-dimensional space understanding.

Granted invention patent “Reservoir fracture modeling method and system” (filed on May 13, 2016, inventor: Zeng Lianbo; Zhao Xiangyuan; Shi Jinxiong; Wang Jipeng; Patent No. CN201610330111.X) provide a reservoir fracture modeling method and system. However, in this method, the planar density distribution strength of each system of fractures is obtained based on the formation fracture characteristics and the distribution characteristics of each system of fracture parameters, then each system of fracture model of single sand body sublayer is established, and then the fracture models are combined to form the fracture three-dimensional model of all systems. This will lead to the consistent distribution pattern of fractures in each substratum, and vague longitudinal distribution law.

Granted invention patent “Fracture modeling method and device” (filed on Oct. 20, 2020, inventors: Li Changhai, Zhao Lun, Fan Zifei, Li jianxin, Wang Shuqin, Zhao Wenqi, Sun Meng, Liu Minghui; Patent No. CN202011122331.4) provides a fracture modeling method and device. This method can effectively characterize fractures with different dip angles, but does not consider the important influence of fracture strikes on seepage and accumulation of the reservoirs.

Granted invention patent “Novel method for quantitative identification of fault-associated fracture of complex tension structural system” (filed on Dec. 3, 2014, inventors: Ou Chenghua, Chen Wei, Li Chaochun; Patent No. CN201410422529.2) provides a novel method for quantitative identification of a fault-associated fracture of a complex tension structural system. Granted invention patent “Multi-scale fracture model of tight and low-permeability reservoir and modeling method thereof” (filed on Oct. 14, 2016, inventors: Zeng Lianbo, Shi Jinxiong; Patent No. CN201610900280.0) provides a multi-scale fracture model of a tight and low-permeability reservoir and a modeling method thereof. The above method has achieved the establishment of a model of an induced fracture near the fault, but the reliability of development of the fracture in the stability zone away from the fault needs to be verified.

Granted invention patent “Method for identifying glutenite fracture” (filed on Nov. 27, 2013, inventors: Cao Gang, Wang Wei, Zhuang Xuchao, Zhang Xiaozhen, Lv Shichao and Zhang Huafeng; Patent No. CN201310610148.2) provides a method for identifying a glutenite fracture. Granted invention patent “Shale gas reservoir lamellation fracture three-dimensional modeling method” (filed on Jan. 15, 2016, inventors: Ou Chenghua, Li Chaochun, Xiong Hongli, Lu Wentao, Zhang Qian, Zhang Mengling, Han Chiyu; Patent No. ZL201610028053.3) provides a shale gas reservoir lamellation fracture three-dimensional modeling method. Granted invention patent “Structural fracture 3D modeling method based on geometric recovery of structural plane” (filed on Jan. 15, 2016, inventors: Ou Chenghua, Li Chaochun, Xiong Hongli, Lu Wentao, Zhang Qian, Zhang Mengling, Han Chiyu; Patent No. ZL201610029135.X) provides a structural fracture 3D modeling method based on geometric recovery of structural plane. All the above methods only involve fractures with single lithology or a single type of fractures, and do not involve other genetic types of fractures.

It can be seen that because the static, dynamic, macroscopic and microscopic multivariate information of natural fractures in all types of related data are not fully excavated, it is difficult to accurately and reliably identify various types of natural fractures induced by faults near faults and natural fractures in the structurally stable zones away from the faults only by relying on the above technical methods, and it is difficult to precisely and accurately depict the planar and longitudinal distribution characteristics and laws of the natural fractures by means of the established three-dimensional network models of various types of natural fractures.

### SUMMARY

An objective of the present disclosure is to solve the defects in the prior art, and provides a modeling method for identifying a natural fracture using a grading and classification quantitative identifier.

A modeling method for identifying a natural fracture using a grading and classification quantitative identifier includes:
step S1, constructing a wellbore natural fracture grading and classification quantitative identifier by means of fusion of static and dynamic information and macroscopic and microscopic information;
step S2, constructing a spatial natural fracture grading and classification quantitative identifier by means of seismic attribute multi-level nested variable time window optimization; and
step S3, establishing a natural fracture three-dimensional network model using a grading and classification modeling method.

In some embodiments, step S1 further includes:
step S11, analyzing a dynamic evolution relationship between a stress field and lithofacies to establish natural fracture grading and classification characteristic patterns;
step S12, constructing a natural fracture in-situ grading characteristic quantitative identifier by fusing microscopic and macroscopic information of a core; and
step S13, establishing the wellbore natural fracture grading and classification quantitative identifier by fusing the static and dynamic information.

Establishing the natural fracture grading and classification characteristic patterns includes:
determining a grading characteristic pattern that the natural fracture shows a stratum-along fracture, a low-angle fracture, or a high-angle fracture in a longitudinal direction; and
determining a classification characteristic pattern that a natural fracture plane changes in different directions.

In some embodiments, step S12 further includes:
step S121, establishing a stratum-along fracture, low-angle fracture and high-angle fracture characteristic identification pattern by fusing the microscopic and macroscopic information of the core based on the grading characteristic pattern and the classification characteristic pattern of the natural fracture;
step S122, establishing a stratum-along fracture, low-angle fracture and high-angle fracture characteristic quantitative identifier based on the stratum-along fracture, low-angle fracture and high-angle fracture characteristic identification pattern, which is a natural fracture grading characteristic quantitative identifier; and
step S123, constructing a natural fracture in-situ grading characteristic quantitative identifier by means of core proper-horizon restoration, and implementing in-situ characterization of the grading characteristic pattern of the natural fracture.

In some embodiments, step S13 further includes:
step S131, extracting response characteristics of static information of a graded fracture based on an in-situ characterization result of the natural fracture grading characteristic quantitative identifier, and establishing a natural fracture grading characteristic static logging information quantitative identifier;
where the response characteristics include a lithologic indication curve, a porosity indication curve, a resistivity indication curve, an array acoustic wave amplitude curve and an array acoustic wave anisotropy curve corresponding to each of the stratum-along fracture, the low-angle fracture, and the high-angle fracture;
step S132, verifying the degree of development of a natural fracture at the same wellbore position by fusing response characteristics of dynamic output information of the wellbore, and establishing a natural fracture grading characteristic dynamic output information quantitative identifier; and
step S133, establishing a wellbore natural fracture classification characteristic quantitative identifier by fusing static and dynamic information.

The establishing a wellbore natural fracture classification characteristic quantitative identifier includes:
step S1331, employing array acoustic anisotropic interpretation, geostress azimuth indication and dynamic changes in production, based on the natural fractures at different depths in a longitudinal direction identified by the natural fracture grading characteristic quantitative identifier;
step S1332, analyzing a planar azimuth change characteristic of a natural fracture in a depth-specific layer to form a static and dynamic quantitative identification for different systems of natural fractures in the same layer; and
step S1333, establishing a wellbore natural fracture classification characteristic quantitative identifier.

In some embodiments, step S2 further includes:
step S21, constructing a structural smoothness variable time window optimization quantitative identifier for optimum natural fracture suitability;
step S22, constructing a variance cube variable time window optimization quantitative identifier for improving sensitivity of the natural fracture; and
step S23, constructing an ant-dynamic-tracking based spatial fracture grading and classification quantitative identifier.

In some embodiments, step S21 further includes:
step S211, inputting a seismic amplitude data volume;
step S212, comparing filtering modes to screen out a filtering mode with a maximum resolution and signal-to-noise ratio suitable for natural fracture characterization; and
step S213, optimizing the size of a filtering time window in different directions in a three-dimensional space, and constructing the structural smoothness variable time optimization quantitative identifier for optimum natural fracture suitability.

Step S22 further includes:
setting a processing result of the structural smoothness variable time window optimization quantitative identifier for optimum natural fracture suitability as a main input, and comparing difference between processing results in different directions and for different filtering variable time windows by means of optimization of filtering bandwidths of a inline and a crossline and optimization of a vertical smooth filtering variable window length, thus weakening stratum-along information;
correcting dip angles of variance cubes in different directions by means of proportional optimization of variable time window in a vertical direction, the inline and the crossline, thus forming fracture structures with different occurrences;
ensuring that computation of variance along a dip-angle plane has real information coverage by means of optimization of a variable correction threshold of the dip-angle plane; and
enhancing the sensitivity of discontinuous structures by means of structural characteristics comprising smooth dip angle steering, and prominent faults and fractures.

In some embodiments, in step S23, the sensitivity of the natural fracture is improved using the variable time window optimization quantitative identifier, an established variance cube is used as a main input and an identification result of the wellbore natural fracture grading and classification quantitative identifier is used as a constraint to optimize ant tracking patterns, thus forming ant tracking patterns aiming at fracture information of different scales, which includes:
optimizing an initial ant tracking range to form an initial ant tracking range capable of capturing more tracking traces;
adjusting ant tracking azimuth deviation to form a maximum legal distance at which the ant deviates upon searching in different directions;
optimizing an ant motion step size to form a maximum distance at which the ant searches effectively forward;
optimizing an illegally allowable step size to form an illegally allowable maximum search distance when no local abnormal point is found in the previous step, thus tracking abnormal information;
optimizing a legally allowable step size, establishing a legally allowable step size with a maximum value based on the implementation of the illegally allowable step size, thus achieving the connection, recording and output of real abnormal points; and
optimizing an ant tracking stop criterion, and defining an illegally allowable step size stop criterion by comparing with the development characteristics and distribution range of the natural fracture, thus stopping illegal ant tracking process.

In some embodiments, step S3 further includes:
step S31, establishing a depth-domain natural fracture distribution and development space prediction model through time-depth information conversion based on the spatial natural fracture grading and classification quantitative identifier, normalizing the depth-domain natural fracture distribution and development space prediction model, and setting a grid value of a developed fracture to be 1, and a grid value of an undeveloped fracture to be 0;
step S32, quantitatively picking up natural fracture grading and classification feature parameters;

where the quantitatively picking up the natural fracture grading and classification feature parameters includes:
step S321, converting the normalized depth-domain natural fracture distribution and development space prediction model into a distribution planar graph of substratum natural fractures in different strata and systems;
step S322, establishing a natural fracture grading and classification onset index model using a facies-controlled modeling strategy; and
step S323, constructing a natural fracture grading and classification development strength model by setting an amplitude value as an indication of a development density of the natural fracture and onset index models of different systems of natural fractures as the constraint conditions; and
step S33, establishing a natural fracture three-dimensional network model using a grading and classification modeling method.

The modeling method is modeling method for forming a natural fracture grading and classification three-dimensional discrete network model with the grading and classification natural fracture onset index model as a spatial constraint of an interpolation of the natural fracture and the grading and classification natural fracture strength model as a main input.

The present disclosure has the following beneficial effects.

The method not only precisely and accurately depicts planar and longitudinal distribution characteristics and laws of natural fractures, but also solves the problem of accurate and reliable identification of induced fractures near faults and natural fractures in structurally stable zones far away from the faults, thus providing a reliable geological model and technical support for the accurate, reliable and rapid construction of a grading and classification three-dimensional network model of natural fractures and for scientific and efficient development of conventional fractured reservoirs, and unconventional oil-gas reservoirs such as, tight sandstone, tight carbonate rocks, and shale oil-gas.

### BRIEF DESCRIPTION OF THE DRAWINGS

To describe the technical solutions of the present disclosure or in the prior art more clearly, the following briefly introduces the accompanying drawings required for describing the embodiments or the prior art. Apparently, the accompanying drawings in the following description show merely some embodiments of the present disclosure, and those of ordinary skill in the art may still derive other drawings from these accompanying drawings without creative efforts.

FIG. 1 is a diagram of technical process according to the present disclosure;

FIG. 2A is a picture of a longitudinal grading characteristic pattern of a stratum-along fracture according to the present disclosure;

FIG. 2B is a picture of a longitudinal grading characteristic pattern of a low-angle fracture according to the present disclosure;

FIG. 2C is a picture of a longitudinal grading characteristic pattern of a high-angle fracture according to the present disclosure;

FIG. 3A is a diagram showing conventional logging identification of a high-angle fracture as a longitudinal grading according to the present disclosure;

FIG. 3B is a diagram showing array acoustic wave amplitude interpretation and identification of the high-angle fracture according to the present disclosure;

FIG. 3C is a diagram showing array acoustic anisotropic interpretation and identification of the high-angle fracture according to the present disclosure;

FIG. 3D is a diagram showing dynamic changes identification of the high-angle fracture according to the present disclosure;

FIG. 4A is a diagram showing conventional logging identification of a low-angle fracture as an another longitudinal grading according to the present disclosure;

FIG. 4B is a diagram showing array acoustic wave amplitude interpretation and identification of the low-angle fracture according to the present disclosure;

FIG. 4C is a diagram showing array acoustic anisotropic interpretation and identification of the low-angle fracture according to the present disclosure;

FIG. 4D is a diagram showing dynamic changes identification of the low-angle fracture according to the present disclosure;

FIG. 5A is a diagram showing conventional logging identification of a stratum-along fracture as a further longitudinal grading according to the present disclosure;

FIG. 5B is a diagram showing array acoustic wave amplitude interpretation and identification of the stratum-along fracture according to the present disclosure;

FIG. 5C is a diagram showing array acoustic anisotropic interpretation and identification of the stratum-along fracture according to the present disclosure;

FIG. 5D is a diagram showing dynamic changes identification of the stratum-along fracture according to the present disclosure;

FIG. 6A an image showing geostress azimuth identification of the natural fracture in north-east direction as a planar classification according to the present disclosure;

FIG. 6B a diagram showing array acoustic anisotropic interpretation and identification the natural fracture in the north-east direction according to the present disclosure;

FIG. 6C a diagram showing dynamic changes identification of the natural fracture in the north-east direction according to the present disclosure;

FIG. 7A an image showing geostress azimuth identification of the natural fracture in east-west direction as an another planar classification according to the present disclosure;

FIG. 7B a diagram showing array acoustic anisotropic interpretation and identification of the natural fracture in the east-west direction according to the present disclosure;

FIG. 7C a diagram showing dynamic changes identification of the natural fracture in the east-west direction according to the present disclosure;

FIG. 8A an image showing geostress azimuth identification of the natural fracture in south-north direction as a further planar classification according to the present disclosure;

FIG. 8B a diagram showing array acoustic anisotropic interpretation and identification of the natural fracture in the south-north direction according to the present disclosure;

FIG. 8C a diagram showing dynamic changes identification of the natural fracture in the south-north direction according to the present disclosure;

FIG. 9A an image showing geostress azimuth identification of the natural fracture in north-west direction as a yet planar classification according to the present disclosure;

FIG. 9B a diagram showing array acoustic anisotropic interpretation and identification of the natural fracture in the north-west direction according to the present disclosure;

FIG. 9C a diagram showing dynamic changes identification of the the natural fracture in the north-west direction according to the present disclosure;

FIG. 10A is a diagram showing array acoustic anisotropic interpretation in near east-west direction according to the present disclosure;

FIG. 10B is a diagram showing array acoustic anisotropic interpretation in near east-north direction according to the present disclosure;

FIG. 10C is a diagram showing array acoustic anisotropic interpretation in near west-north direction according to the present disclosure;

FIG. 10D is a diagram showing array acoustic anisotropic interpretation in near north-south direction according to the present disclosure;

FIG. 11 is an image showing plane curvature change and geostress direction expansion according to the present disclosure;

FIG. 12A is an image of dynamic tracking of the large fault according to the present disclosure;

FIG. 12B is an image of dynamic tracking of the small fracture according to the present disclosure;

FIG. 13A is an image of longitudinal graded characterization of natural fractures according to the present disclosure;

FIG. 13B is an image of planar classified characterization of natural fractures according to the present disclosure;

FIG. 14 is an image of a distribution and development spatial prediction model of a natural fracture according to the present disclosure;

FIG. 15A is an image of a natural fracture onset index model in west-east direction according to the present disclosure;

FIG. 15B is an image of a natural fracture onset index model in south-north direction according to the present disclosure;

FIG. 15C is an image of a natural fracture onset index model in west-south direction according to the present disclosure;

FIG. 15D is an image of a natural fracture onset index model in west-north direction according to the present disclosure;

FIG. 16A is an image of a development strength model in west-east direction according to the present disclosure;

FIG. 16B is an image of a development strength model in south-north direction according to the present disclosure;

FIG. 16C is an image of a development strength model in west-south direction according to the present disclosure;

FIG. 16D is an image of a development strength model in west-north direction according to the present disclosure;

FIG. 17A is an image of the three-dimensional discrete network model of natural fracture in east-west direction according to the present disclosure;

FIG. 17B is an image of the three-dimensional discrete network model of natural fracture in north-south direction according to the present disclosure;

FIG. 17C is an image of the three-dimensional discrete network model of natural fracture in north-west direction according to the present disclosure;

FIG. 17D is an image of the three-dimensional discrete network model of natural fracture in north-east direction according to the present disclosure;

FIG. 18 is a columnar statistical chart of azimuthal distribution of a natural fracture according to the present disclosure;

FIG. 19 is a columnar statistical chart of length distribution of a natural fracture according to the present disclosure; and

FIG. 20 is a columnar statistical chart of dip angle distribution of a natural fracture according to the present disclosure.

### DETAILED DESCRIPTION OF THE EMBODIMENTS

It should be understood that specific embodiments described here are only used to illustrate rather than limiting the present disclosure.

To understand the technical features, objectives and beneficial effects of the present disclosure more clearly, the technical solution of the present disclosure is described in detail below. Apparently, the described embodiments are merely a part rather than all of the embodiments of the present disclosure, and thus cannot be construed as the limitation of implementable range of the present disclosure. All other embodiments obtained by those of ordinary skill in the art based on the embodiments of the present disclosure without creative efforts shall fall within the protection scope of the present disclosure.

Aiming at characterization and modeling of various natural fractures in conventional fractured oil-gas reservoirs and unconventional oil-gas reservoirs such as tight sandstone, tight carbonate rocks and shale oil-gas, a natural fracture grading and classification quantitative identifier and a three-dimensional modeling method are provided. Firstly, by analyzing a dynamic evolution relationship between a stress field and lithofacies, natural fracture grading and classification characteristic patterns are established. On this basis, a natural fracture in-situ grading characteristic quantitative identifier is constructed by fusing microscopic and macroscopic information of a core. Further, a wellbore natural fracture grading and classification characteristic quantitative identifier is established by fusing static and dynamic information. By using the seismic attribute multi-level nested variable time window technology, a structural smoothness variable time window optimization quantitative identifier for optimum natural fracture suitability, a variance cube variable time window optimization quantitative identifier for improving sensitivity of the natural fracture, and an ant-dynamic-tracking based natural fracture grading and classification quantitative identifier are constructed. By adopting above technical paths and means and methods, the planar and longitudinal distribution laws of the natural fractures can be effectively characterized, and the problem of accurate and reliable identification of induced fractures near faults and natural fractures in structurally stable zones far away from the faults can be solved. Finally, on the basis of an identification result of the natural fracture grading and classification quantitative identifier, the natural fracture grading and classification characteristic parameters are quantitatively picked. Further, a grading and classification modeling method is adopted to achieve accurate, reliable and rapid construction of the natural fracture grading and classification three-dimensional network model, thus completing the precise and accurate description of the planar and longitudinal distribution characteristics and laws of the natural fracture.

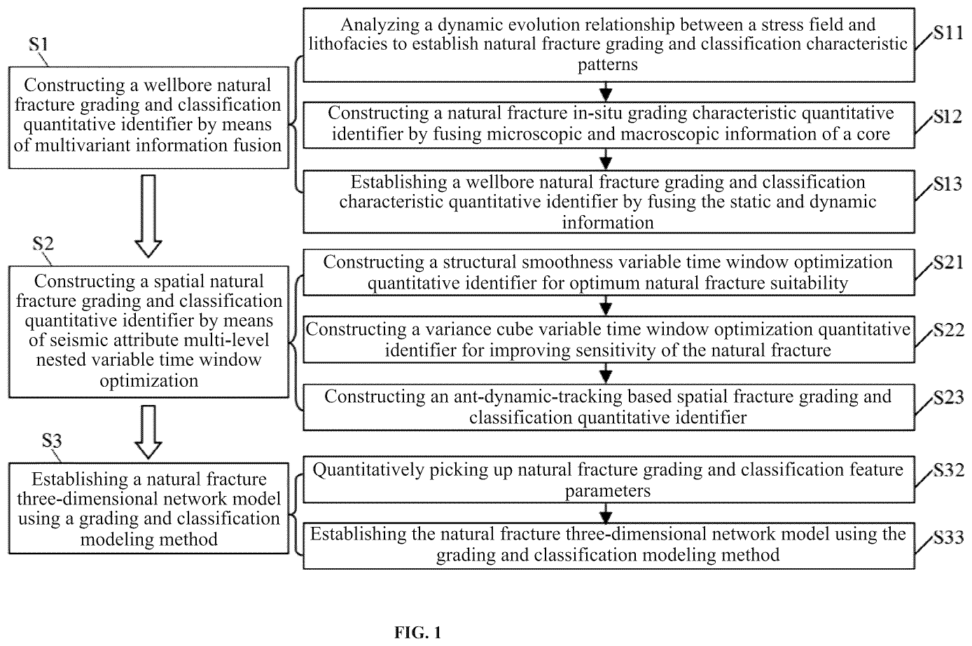

The detailed technical solution process block is as shown in FIG. 1.

1. A wellbore natural fracture grading and classification quantitative identifier is constructed by means of multivariant information fusion.

Aiming at the technical problem that single information cannot accurately and clearly characterize the occurrence characteristics and spatial distribution of natural fractures due to complex genetic mechanism and configuration characteristics, the present disclosure proposes constructing a wellbore natural fracture grading and classification quantitative identifier by means of multivariant information fusion. Firstly, by analyzing a dynamic evolution relationship between a stress field and lithofacies, natural fracture grading and classification characteristic patterns are established. On this basis, a natural fracture in-situ grading characteristic quantitative identifier is constructed by fusing microscopic and macroscopic information of a core, thereby calibrating the wellbore fracture information. Further, a wellbore natural fracture grading and classification characteristic quantitative identifier is established by fusing static and dynamic information, thus achieving accurate and reliable identification of grading and classification characteristics of the natural fracture.

(1) Natural fracture grading and classification characteristic patterns are established by analyzing a dynamic evolution relationship between a stress field and lithofacies.

By means of core observation and laboratory experimental test, the occurrence change characteristics of the natural fracture are analyzed, and the particle composition and crystallization of fracture fillers are analyzed. In the process of geological historical evolution, lithofacies, as a material source of the fracture, and stress, as the external factors including the fracture, play a role in the control of the occurrence and spatial development characteristics of the natural fracture. Grading characteristics that the natural fracture shows a stratum-along fracture, a low-angle fracture, or a high-angle fracture in a longitudinal direction are determined. By means of the change of structural plane curvature, anisotropic interpretation, paleostress change and sedimentary structure change characteristic, structural evolution scale and the direction and magnitude change of stress are analyzed, the influence thereof on the planar distribution of the natural fracture is combed, and the classification characteristics that the natural fracture plane changes in different changes are determined. The longitudinal grading characteristics and the planar classification characteristics jointly construct natural fracture grading and classification characteristic patterns.

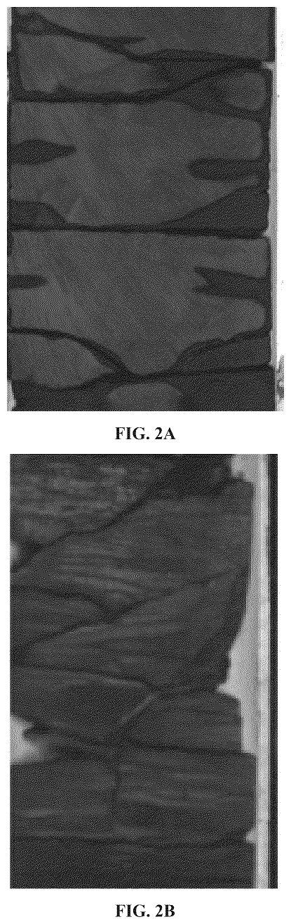

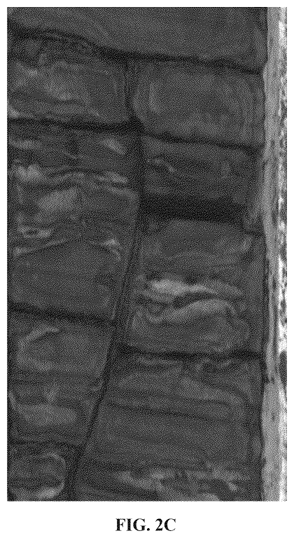

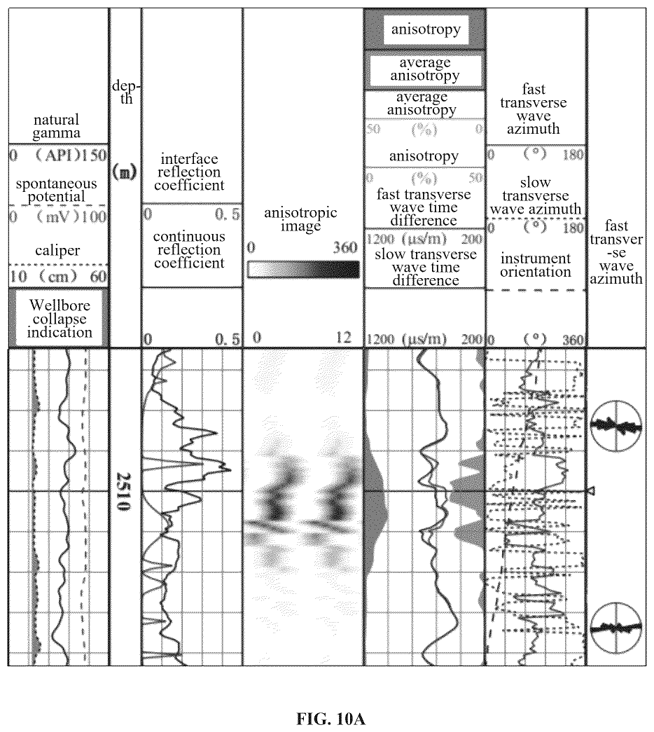

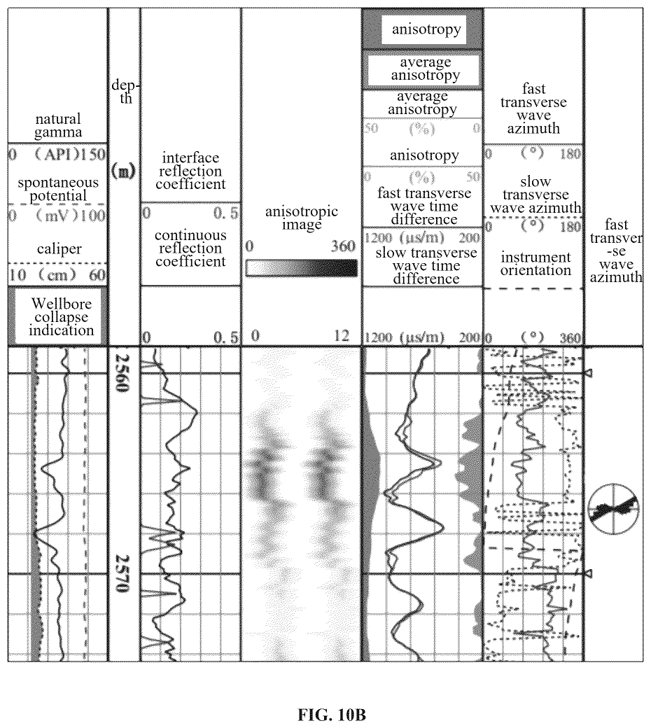

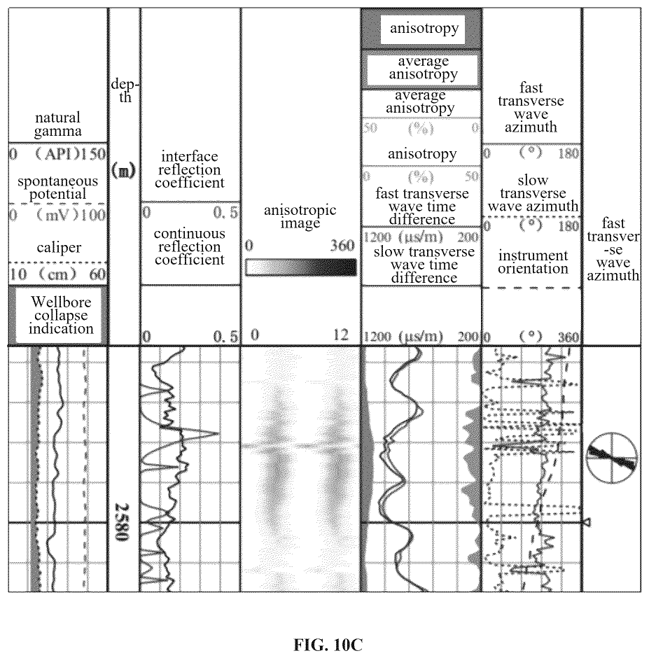

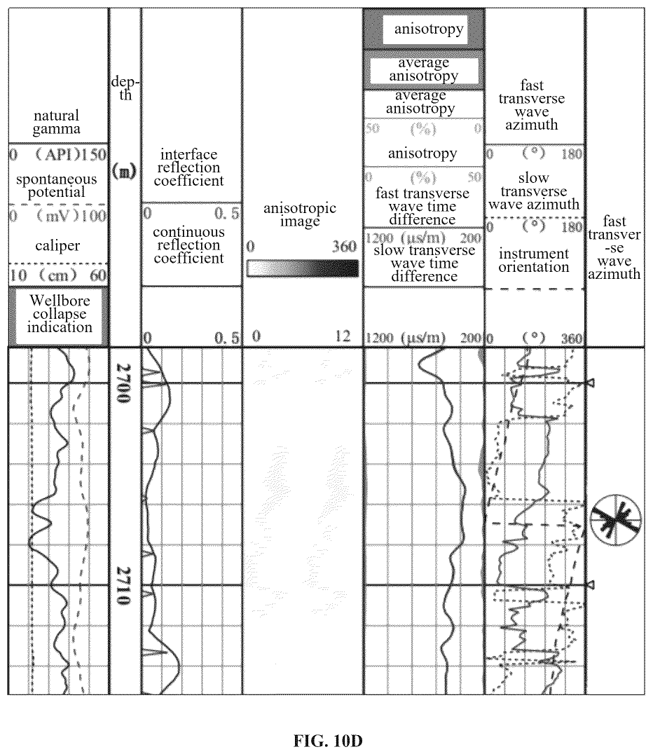

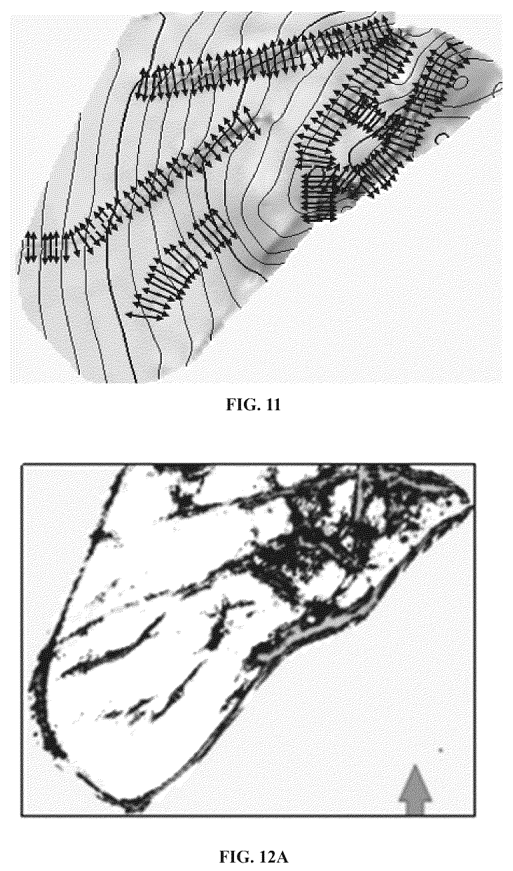

Based on the core observation and experimental test data of six coring wells in a certain study area, the particle composition, pore structure and stress of the rock are analyzed, it is found that a sedimentary environment is in still water or weak dynamic water, and the mineral particles are small in particle size, good in sorting, and deposited in dense layered structure, with less cementation flow. Poor cementation between layers becomes a weak plane (e.g., shale, coalbed methane, etc.), and due to local stress concentration, a stratum-along fracture (FIG. 2A) with a fracture plane roughly parallel to a stratification plane is formed. Meanwhile, when the sedimentary environment is in weak dynamic water, the rock forms a layered or massive structure with good cementation, in which the abrupt change of lithology becomes a fragile plane. When stress concentration occurs, it is easy to form a low-angle fracture with a strike roughly parallel to the strike of the rock stratum and a high-angle fracture with a strike roughly perpendicular to the strike of the rock stratum. When subjected to shear force, the fractures are distributed along a maximum shear stress plane with a certain included angle to a maximum principal compressive stress, which may lead to shear fractures (FIG. 2B and FIG. 2C) with large angles in a homogeneous rock mass. Therefore, the classification characteristics that the natural fractures show the stratum-along fracture, the low-angle fracture and the high-angle fracture in a longitude direction are formed. A geostress direction expansion graph and a single-well anisotropic interpretation graph in each substratum (FIGS. 10A-10D and 11) are obtained by applying a structural curvature method and array acoustic anisotropic interpretation. Due to the influence of multi-period tectonic stress in different directions, the maximum principal stress in each period has different directions, different strengths, and different curvature changes, which leads to the strike distribution of the fracture plane changing in north-east, east-west, north-south and north-west directions, forming the classification characteristics that the natural fracture plane changes in different directions. In summary, the grading and classification characteristic patterns of longitudinal grading and plane classification of the natural fracture in the study area are established (FIGS. 2A-2C and FIGS. 10A-10D and 11).

(2) A natural fracture in-situ grading characteristic quantitative identifier is constructed by fusing microscopic and macroscopic information of the core.

a. A natural fracture grading characteristic quantitative identifier is established by fusing microscopic and macroscopic information of the core.

Based on the constructed natural fracture grading and classification characteristic patterns, the characteristic parameters such as dip angle, length and opening of the natural fracture in nano-micron scale are extracted by a casting sheet and a scanning electron microscope, and a relationship between the strike of the natural fracture and rock strata is analyzed to establish a stratum-along fracture characteristic identification pattern, thus forming a stratum-long fracture characteristic quantitative identifier. The data of the strike of the natural fracture and the formation angle at the macroscopic scale are collected by means of core observation, the mechanical characteristics such as extrusion, tension and shear of the fragile plane are analyzed to establish low-angle fracture and high-angle fracture characteristic identification patterns, thus forming a low-angle fracture characteristic quantitative identifier and high-angle fracture characteristic quantitative identifier, respectively. A quantitative identifier for the grading characteristics including the stratum-along fracture, the low-angle fracture and the high-angle fracture is comprehensively formed.

Table 1 is an established grading characteristic quantitative identifier for a natural fracture in an oilfield in central and eastern China. Through the analysis of the casting sheet and the scanning electron microscope, it is found that the micro-scale fracture strike develops along the rock stratum, and thus a stratum-along fracture characteristic identifier is formed. Data of the strike of the natural fracture and the formation angle at the macroscopic scale are sorted out by means of core observation, the fractures are distributed at low and high angles along the fragile plane, thus forming the low-angle fracture characteristic identifier and the high-angle fracture characteristic identifier which are combined to form a quantitative identifier for grading characteristics including the stratum-along fracture, the low-angle fracture and the high-angle fracture.

TABLE 1
Establishing natural fracture grading characteristic quantitative identifier
by fusing microscopic and macroscopic information of core

| Grading of | | |
|---|---|---|
| natural | Identification of | Identification of development |
| fracture | stress situation | characteristics |
| High-angle | The fracture is | The distribution is related to the |
| fracture | perpendicular to | mechanical properties, |
| | the maximum | heterogeneity and stress state of |
| | principle stress | the rock, controlled by the rock |
| | direction, and a | strata, nearly perpendicular to |
| | displacement | the stratification plane (60-90°), |
| | direction of the | and the fracture plane is usually |
| | fracture is parallel | rough and unsmooth |
| | to a fracture plane | |
| Low-angle | The low-angle | For the well cemented layered or |
| fracture | fracture is | massive structure, the position |
| | distributed along | with difference in lithology |
| | the maximum | becomes the fragile plane, at |
| | stress plane which | which, upon occurrence of stress |
| | has a certain angle | concentration, the fracture is |
| | with the maximum | formed with the dip angle |
| | principal stress | ranging from 45-60°, a width |
| | direction | smaller than that of the |
| | | high-angle fracture, and |
| | | scratches presented on the |
| | | surface |
| Stratum-along | The weak plane of | The fracture plane is roughly |
| fracture | stratification is | parallel to the rock stratum |
| | subjected to local | stratification, and the interlayer |
| | stress | cementation is poor, and a dip |
| | concentration | angle ranges from 10-45° |

b. A natural fracture in-situ grading characteristic quantitative identifier is constructed by means of core proper-horizon restoration, thus implementing in-situ characterization of the grading characteristic pattern of the natural fracture.

The grading characteristic quantitative classifier of the natural fractures including the stratum-along fracture, the low-angle fracture and the high-angle fracture is used for grading and combing. By means of core proper-horizon restoration, the natural fractures correspond to the well trajectory of single well one by one, thus depicting a specific spatial position and grading characteristics of the natural fracture in the wellbore, and achieving the in-situ characterization of the grading characteristic pattern of the natural fracture.

Table 2 show in-situ characterization results of a grading characteristic pattern of the natural fracture in a coring section of No. 1 well in an oilfield in central and eastern China. According to the above method, the specific spatial position and grading characteristics of each fracture in the wellbore are obtained, and the in-situ characterization of the grading characteristic patterns of the stratum-along fracture, the low-angle fracture and the high-angle fracture in the coring section of No. 1 well in the oilfield is achieved.

TABLE 2
Statical table of partial in-situ characterization results of grading characteristic
pattern of natural fracture in coring section of No. 1 well in an oilfield

| | | The | | | | |
|---|---|---|---|---|---|---|
| | Comprehensive | number | | | | Occurrence |
| | nomenclature | of | Length | Opening | Dip angle | characteristic of |
| Depth (m) | of lithology | fractures | (cm) | (mm) | (°) | fracture |
| 2356.56 | Grayish brown | 2 | 3.5/4 | 0.5 | 10/15 | Stratum-along |
| | oil-spotted fine | | | | | fracture |
| | sandstone | | | | | |
| 2356.66 | Grayish brown | 4 | 2-5 | 0.1 | 15-60 | Stratum-along |
| | oil-spotted fine | | | | | fracture, |
| | sandstone | | | | | low-angle |
| | | | | | | fracture |
| 2357.14 | Grayish brown | 1 | 3.6 | 0.1 | 8 | Stratum-along |
| | oil-spotted fine | | | | | fracture |
| | sandstone | | | | | |
| 2357.47 | Grayish brown | 1 | 3.5 | 0.1 | 17 | Stratum-along |
| | oil-spotted fine | | | | | fracture |
| | sandstone | | | | | |
| 2357.57 | Grayish brown | 6 | 2-6 | 0.5 | 5-23/ | Stratum-along |
| | oil-spotted fine | | | | 70-80 | fracture, |
| | sandstone | | | | | high-angle |
| | | | | | | fracture |
| 2357.7 | Grey pelitic | 2 | 3-6 | 0.1-0.2 | 60-80 | High-angle |
| | siltstone | | | | | fracture |
| 2359.65 | Grayish green | 1 | 5 | 0.3 | 80 | High-angle |
| | argillaceous | | | | | fracture |
| | sandstone | | | | | |
| 2360.203 | Grey | 1 | 7 | 0.2 | 0-10 | Stratum-along |
| | argillaceous | | | | | fracture |
| | sandstone | | | | | |
| 2360.313 | Grayish brown | 2 | 2-5 | 0.3 | 30-40 | Low-angle |
| | oil-spotted fine | | | | | fracture |
| | sandstone | | | | | |
| 2360.403 | Grayish brown | 1 | 5 | 0.2 | 75 | High-angle |
| | oil-spotted fine | | | | | fracture |
| | sandstone | | | | | |
| 2360.483 | Grayish brown | 4 | 2-6 | 0.2-0.5 | 10-30 | Stratum-along |
| | oil-spotted fine | | | | | fracture |
| | sandstone | | | | | |
| 2360.688 | Grayish brown | 1 | 2 | 0.5 | 70-90 | High-angle |
| | oil-spotted fine | | | | | fracture |
| | sandstone | | | | | |
| 2360.778 | Grayish brown | 3 | 2.5-10 | 0.5 | 10-50 | Stratum-along |
| | oil-spotted fine | | | | | fracture |
| | sandstone | | | | | |
| 2360.853 | Grayish brown | 6 | 1-4.5 | 0.1-0.5 | 10-45 | Stratum-along |
| | oil-spotted fine | | | | | fracture |
| | sandstone | | | | | |
| 2360.918 | Grayish brown | 6 | 1-7 | 0.1-0.5 | 10-70 | Stratum-along |
| | oil-spotted fine | | | | | fracture, |
| | sandstone | | | | | high-angle |
| | | | | | | fracture |
| 2360.968 | Grayish brown | 7 | 2-5 | 0.1-0.5 | 6-40 | Stratum-along |
| | oil-spotted fine | | | | | fracture |
| | sandstone | | | | | |
| 2361.048 | Grayish brown | 2 | 1-3 | 0.5 | 10/60 | Stratum-along |
| | oil-spotted fine | | | | | fracture, |
| | sandstone | | | | | high-angle |
| | | | | | | fracture |
| 2361.168 | Grayish brown | 2 | 1-2.5 | 0.1 | 70-80 | High-angle |
| | oil-spotted fine | | | | | fracture |
| | sandstone | | | | | |
| 2361.298 | Grayish brown | 1 | 7 | 0.1 | 33 | Stratum-along |
| | oil-spotted fine | | | | | fracture |
| | sandstone | | | | | |
| 2361.398 | Grayish-green | 2 | 2-3 | 0.1 | 30 | Stratum-along |
| | oil-spotted fine | | | | | fracture |
| | sandstone | | | | | |
| 2362.33 | Grayish brown | 1 | 5.5 | 0.1 | 15 | Stratum-along |
| | oil-spotted | | | | | fracture |
| | medium | | | | | |
| | sandstone | | | | | |
| 2362.52 | Grayish brown | 1 | 3.5 | 0.5 | 10 | Stratum-along |
| | oil-spotted fine | | | | | fracture |
| | sandstone | | | | | |

(3) A wellbore natural fracture grading and classification characteristic quantitative identifier is established by fusing static and dynamic information.

a. A wellbore natural fracture grading characteristic quantitative identifier is established by fusing static and dynamic information.

By means of the in-situ characterization results of the natural fracture grading characteristic quantitative identifier, a depth position and grading development characteristics of a fracture in the wellbore are obtained, and these characteristics are further mapped to a logging curve of the same wellbore, and the response characteristics of a lithologic indication curve, a porosity indication curve, a resistivity indication curve, an array acoustic wave amplitude curve and an array acoustic anisotropy curve to these graded fractures such as the stratum-along fracture, the low-angle fracture and the high-angle fracture are extracted successively, and a quantitative identifier for static logging information of grading characteristics of the natural fracture is established, thus forming the capacity of quantitatively identifying the natural fracture by means of the logging information. On this basis, the degree of development of a natural fracture at the same wellbore position is verified by adopting response characteristics of output dynamic information of the wellbore, a quantitative identifier for dynamic output information of grading characteristics of the natural fracture is established, thus forming quantitative identification of dynamic characteristics of the stratum-along fracture, the low-angle fracture and the high-angle fracture at the same depth position of the same wellbore. By means of the fusion of the static and dynamic information, a wellbore natural fracture grading characteristic quantitative identifier is established, which implements the quantitative identification of grading characteristics of the natural fracture of the wellbore by using static logging information combined with the output dynamic information.

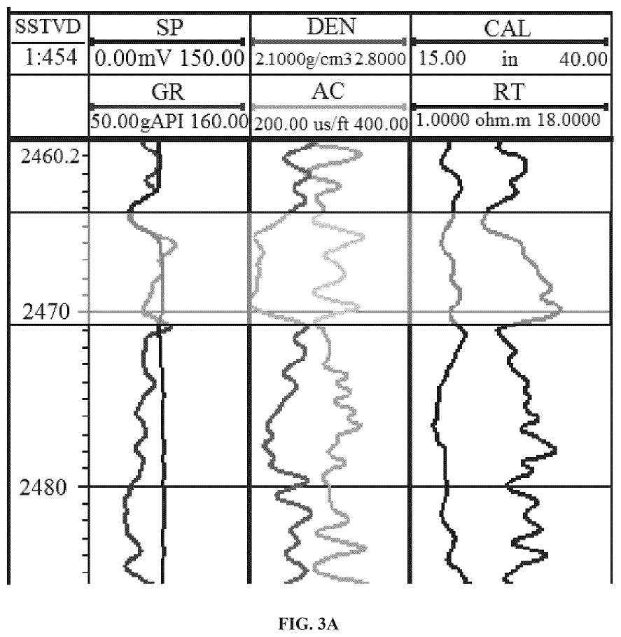

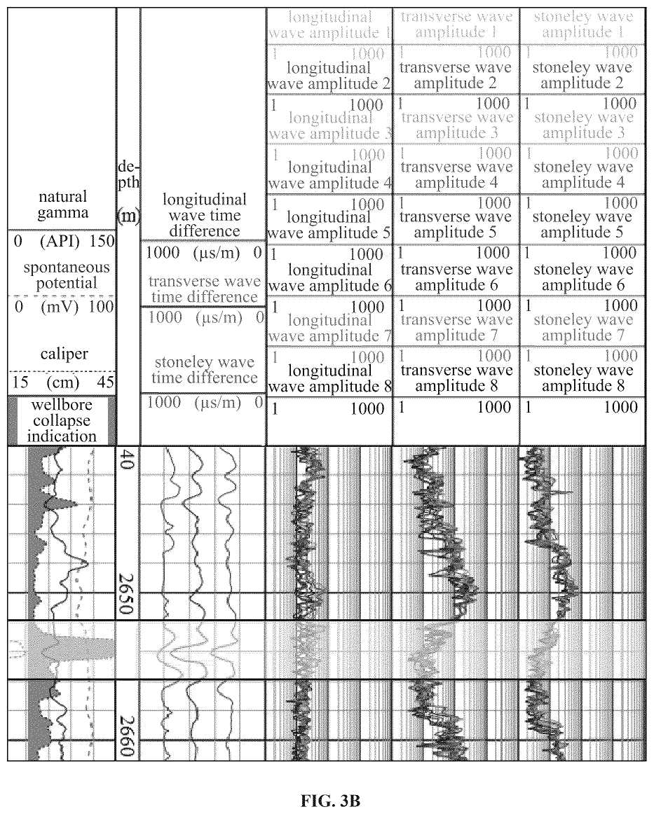

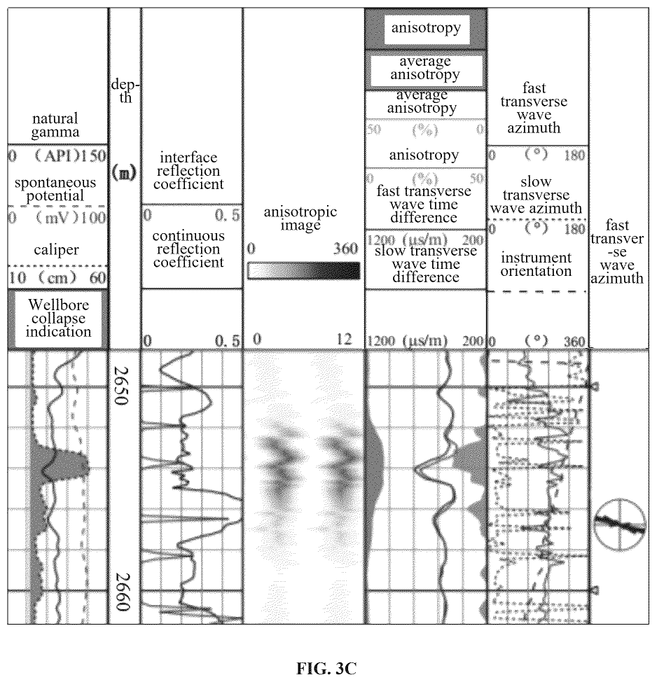

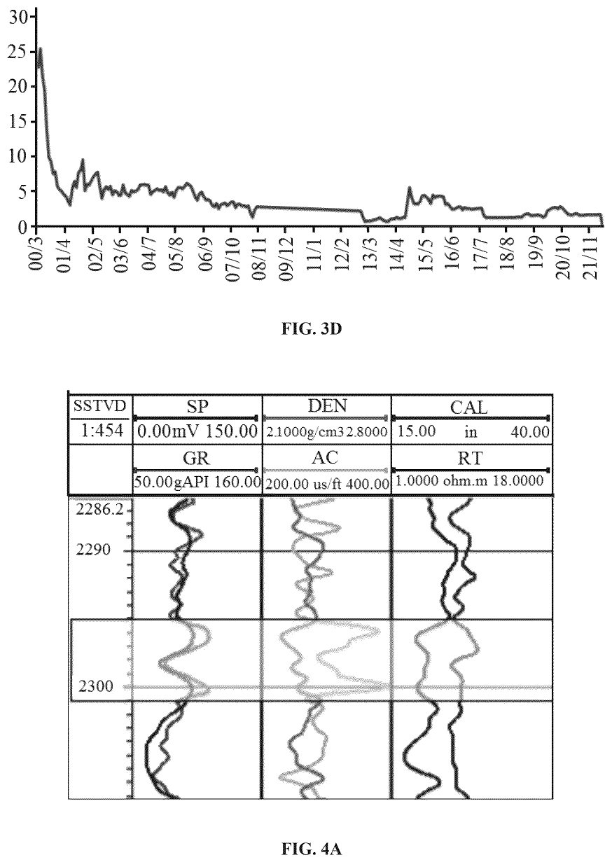

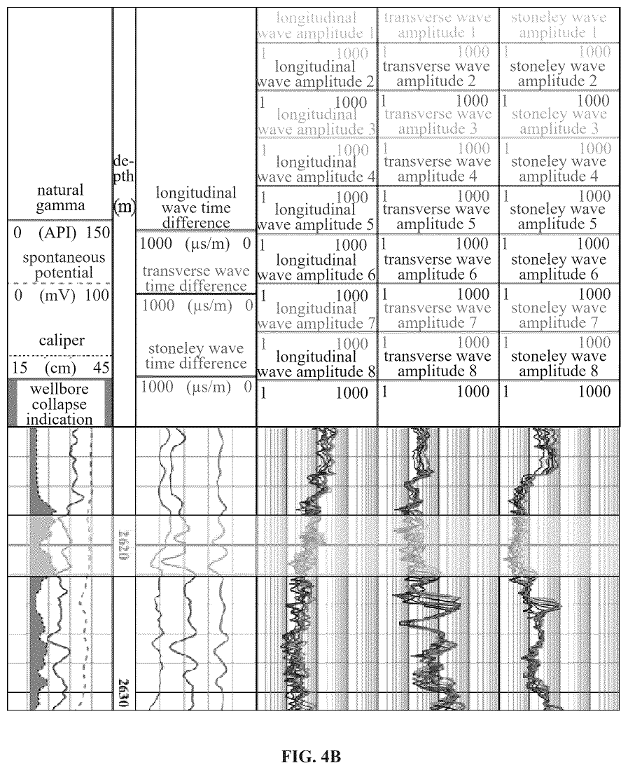

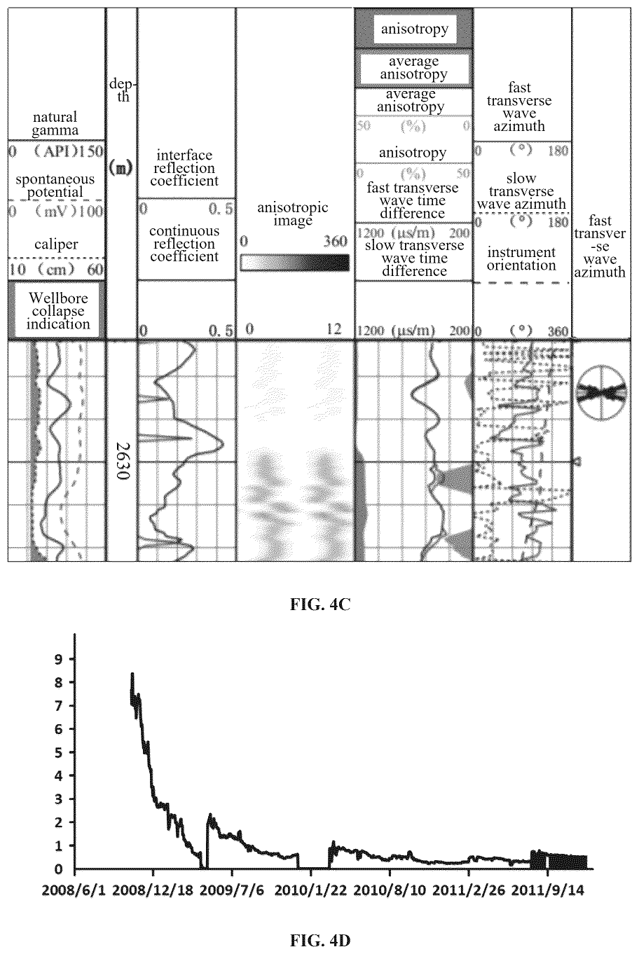

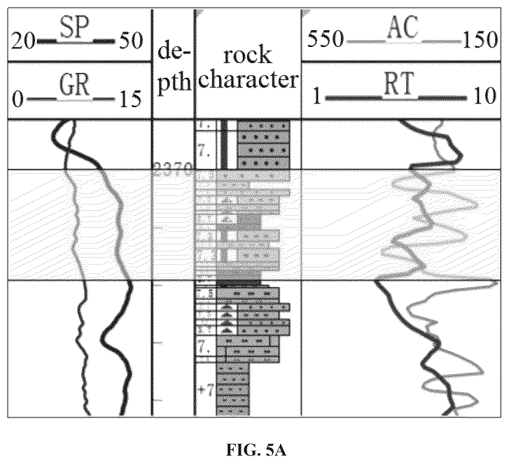

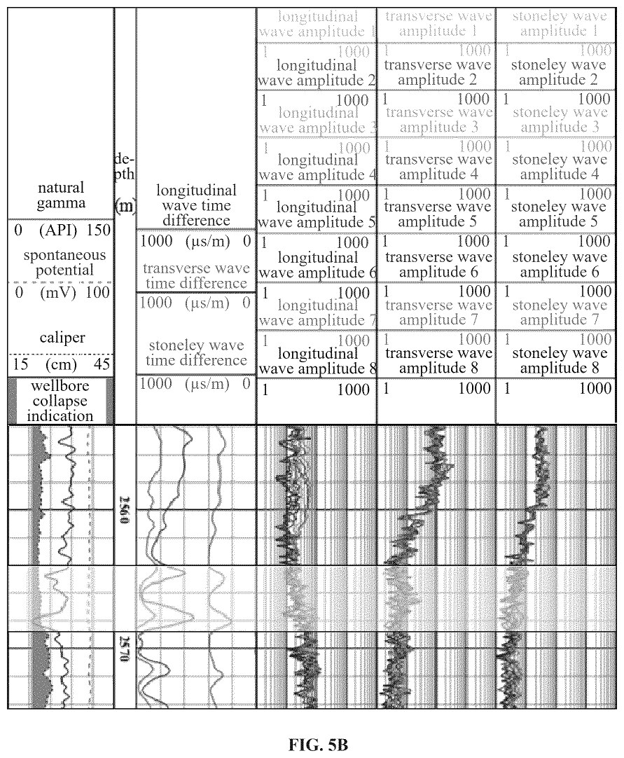

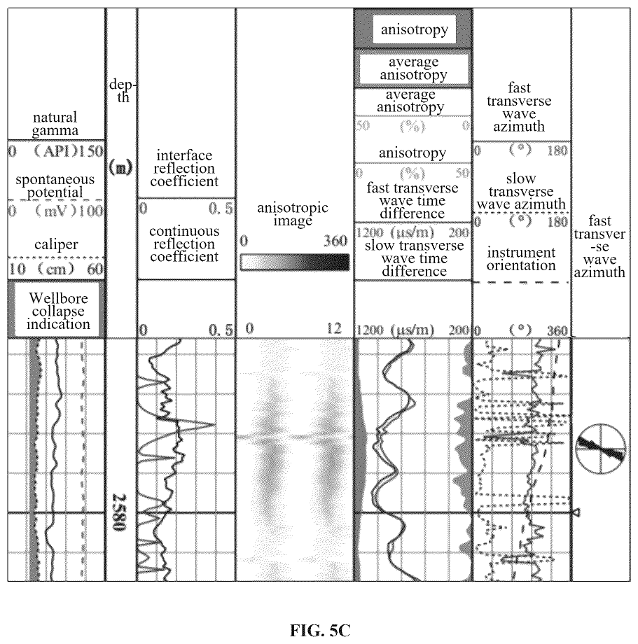

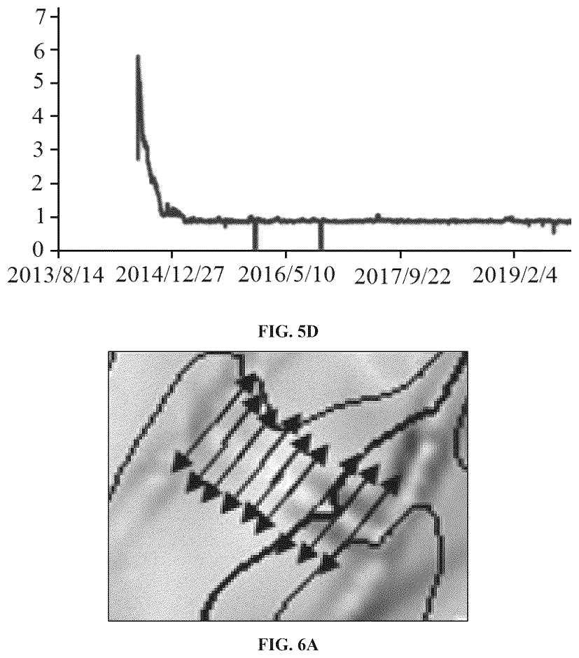

Core proper-horizon restoration results of coring sections of six wells in the study area correspond to the lithology indication curve (caliper CAL, natural gamma GR, spontaneous potential SP), the porosity indication curve (density DEN, neutron CNL, acoustic time difference AC) and the resistivity indication curve (dual lateral resistance RLL, formation true resistivity RT and flushed zone resistivity Rxo) one by one. When the fracture develops, SP shows negative anomaly with low value at the fracture position. GR often shows low value at the fracture position, and shows a low peak in the case of the fracture (except for the increase of GR caused by uranium in groundwater). RLL (RT and Rxo) is sensitive to the fracture, due to the invasion of a drilling fluid into the low-angle fracture, the dual lateral resistance declines obviously, and the decline amplitude is related to the opening degree and often in the form of peaks and teeth, with no amplitude difference to a slight negative amplitude difference. However, as the drilling fluid does not penetrate deeply into the high-angle fracture, the dual lateral resistance is high or medium, which is a positive difference, and there will be many smaller peaks. When the low-angle fracture exists, the acoustic time difference AC increases, the curve is slightly serrated or in a cycle-skip phenomenon, and has no response to the high-angle fracture. The expansion or reducing of the caliper CAL has a great relationship with formation lithology. If the formation is mudstone and the fracture is the high-angle fracture, the development is dense, and the phenomenon of diameter expansion may occur. If the formation is a permeable sandstone, as the attachment of a mud cake leads to the reducing of the logging curve, the analysis should be carried out in combination with the SP curve. The DEN is reduced in comparison with the surrounding rock in a case of fracture, the curve is in a peak shape. The density of the low-angle fracture decreases and the neutron porosity logging value increases, while the density of the high-angle fractures decrease, and has the magnitude difference from the neutron porosity. However, the density curve can only reflect the fracture with which a polar plate makes contact. CNL reflects the water-filled porosity of mud invasion, and the porosity of the tight rock matrix is particularly low, such that the neutron logging can directly reflect the degree of development of the fracture, and the porosity of neutron measurement increases in the case that the fracture develops with filling of bound water or formation water or oil. In imaging logging, the time difference of P-wave and S-wave in the array acoustic wave amplitude interpretation result diagram increases, the amplitude decreases, and the Stoneley wave amplitude decreases, indicating that the open fracture is developed. In the array acoustic anisotropic interpretation result graph, as the stress is consumed due to the existence of the fracture, the brightness of the anisotropy image is weak, a reflection coefficient increases, and the fast and slow S-waves are separated, the azimuths of the fast and slow S-waves are orthogonal, and the azimuth of the fast S-waves is parallel to the fracture strike. The dynamic change process of high initial production and rapid decline of daily fluid output further proves the existence of the natural fracture in this position. Based on the fusion of the above static and dynamic information, a wellbore natural fracture grading characteristic quantitative identifier (FIGS. 3A-3D, 4A-4D, and 5A-5D) is established, which completes the in-situ characterization of the natural fracture in the wellbore based on logging and dynamic changes, and establishes the grading characteristic pattern of the natural fracture in the wellbore.

b. A wellbore natural fracture classification characteristic quantitative identifier is established by fusing static and dynamic information.

The quantitative characterization of various natural fractures at different depths in the longitudinal direction is formed by means of the wellbore natural fracture grading characteristic quantitative identifier. For the identified natural fractures at different depths in the longitudinal direction, a wellbore natural fracture classification characteristic quantitative identifier is established using the array acoustic anisotropic interpretation, the geostress azimuth indication and dynamic changes in production, and the planar azimuth change characteristics of the natural fracture at a depth-specific layer are analyzed. On the one hand, a static information-based classification characteristic pattern of the natural fracture is formed, and on the other hand, the dynamic changes in production is used to further prove the fracture development situation at the well position in the substratum. Based on this, the static and dynamic quantitative identification of different systems of natural fractures in the same stratum is formed, thus establishing a classification characteristic pattern of the natural fracture in the wellbore by means of the fusion of static and dynamic information.

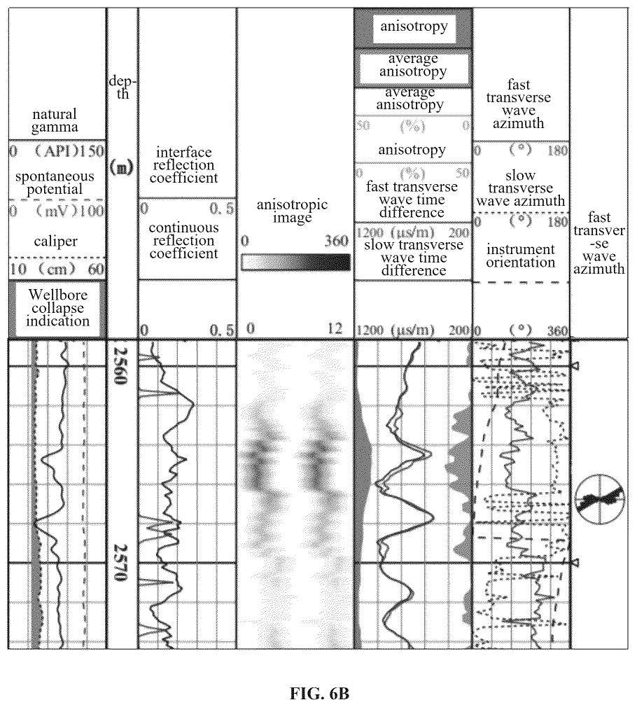

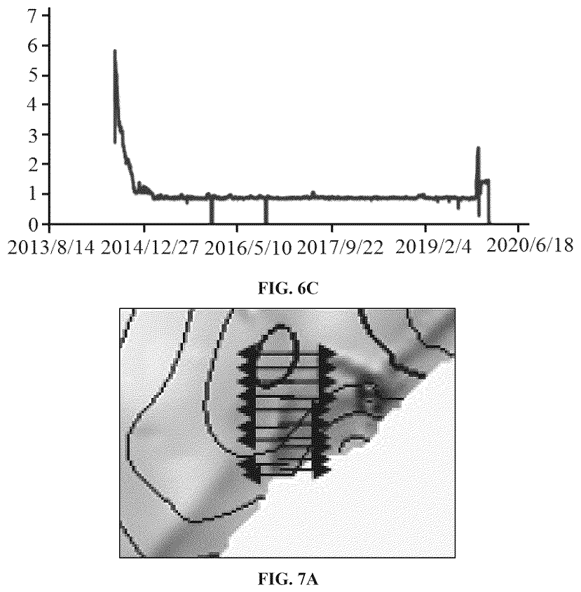

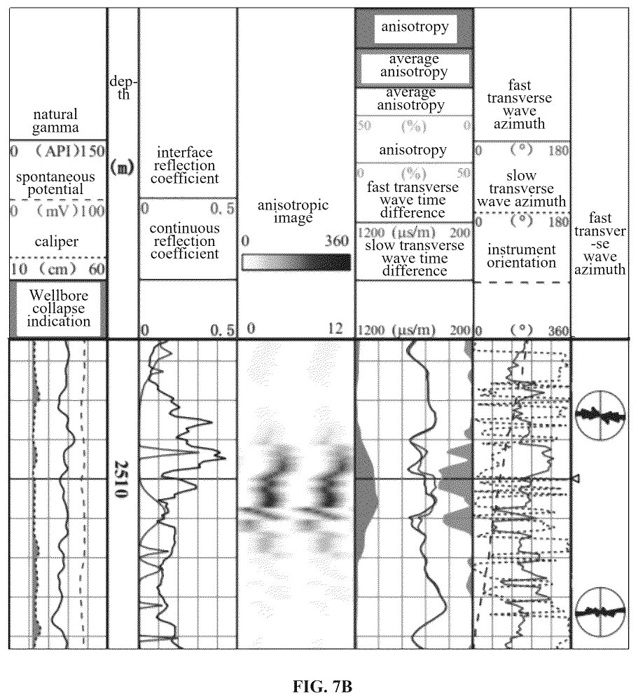

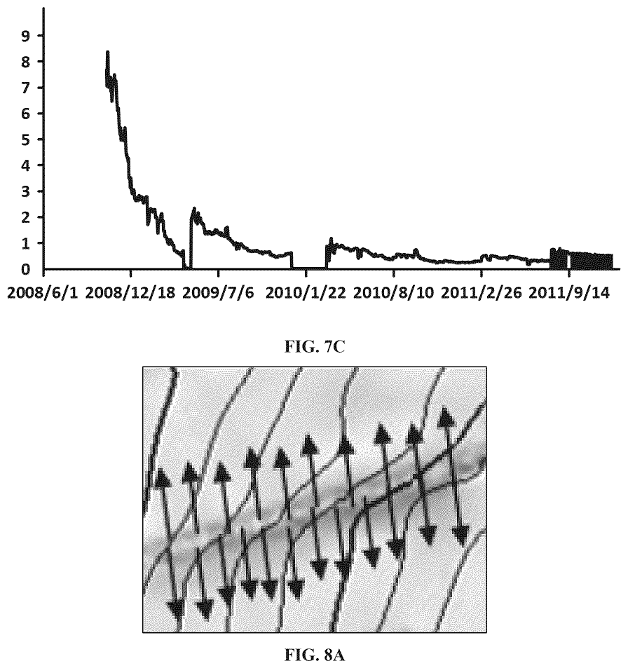

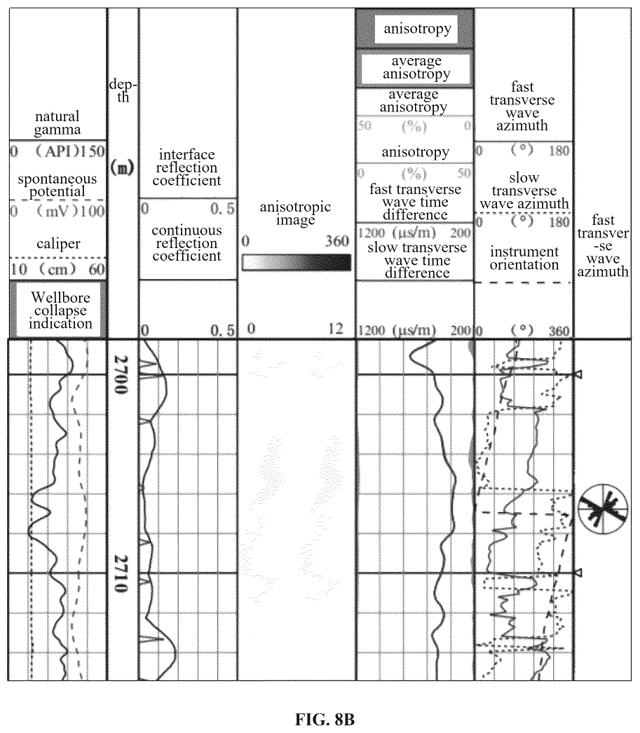

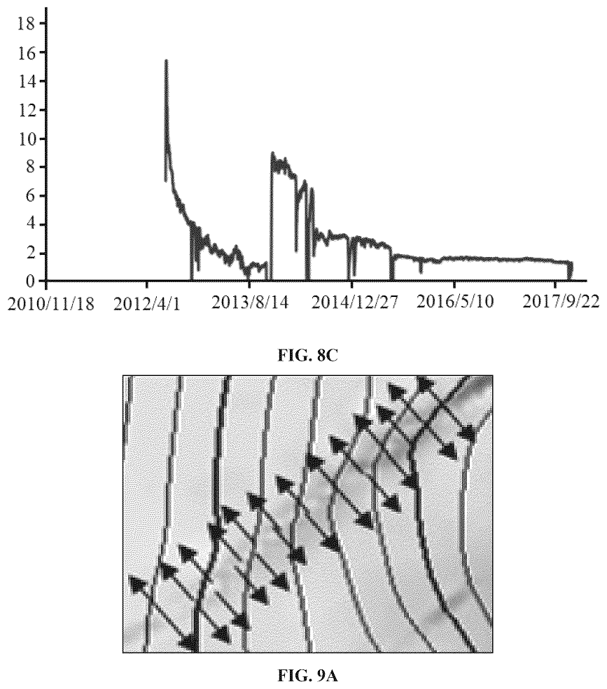

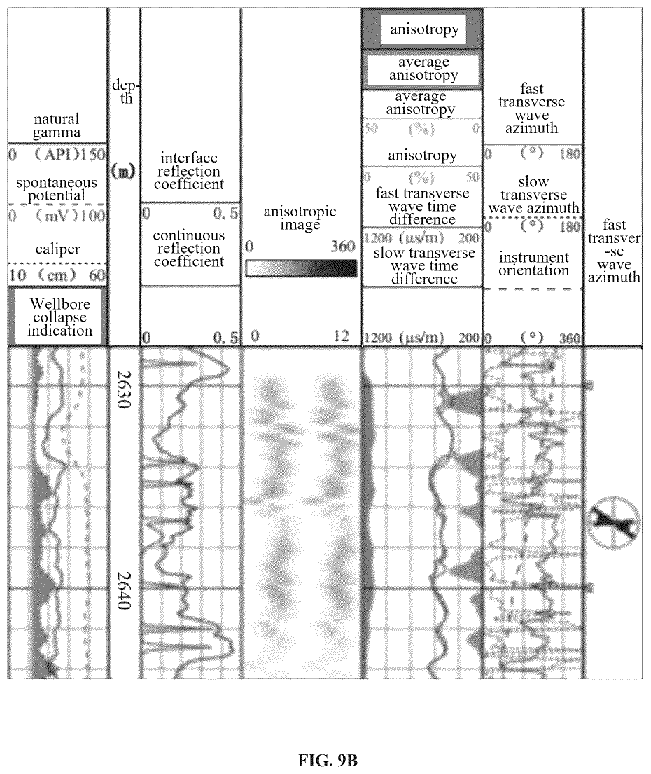

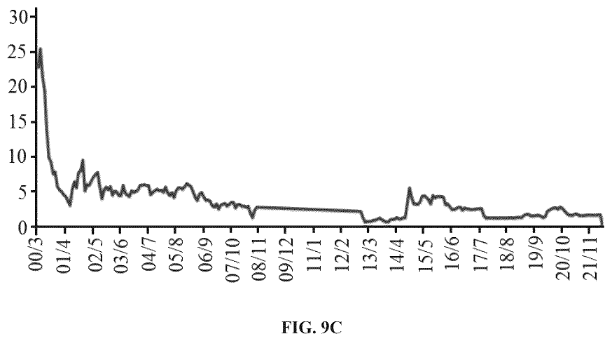

The wellbore natural fracture classification characteristic quantitative identifier is used to implement the quantitative identification of the classification characteristics of the wellbore natural fracture in a study area. In the azimuth plane of fast S-waves, the natural fracture changes in north-east, east-west, north-south and north-west directions. However, the azimuth of geostress is characterized by the change of tectonic curvature, and the strike of the natural fracture develops in a direction perpendicular to the maximum principal stress direction, thus characterizing the distribution of the natural fracture in a certain stratum plane in north-east, east-west, north-south and north-west directions. Based on this, the classification characteristic model of the natural fracture with static information of different stratum planes is established. The dynamic changes in production of high initial production and rapid decline of daily fluid output further proves the existence of the natural fracture in this position. Based on this, a quantitative identifier for the planar classification characteristics of the natural fractures in the wellbore in the north-east, east-west, north-south and north-west directions is established (FIGS. 6A-6C, 7A-7C, 8A-8C, and 9A-9C), which forms an accurate characterization and depiction of the four types of planar classification characteristics of the natural fractures in the wellbore in different sub-strata in the study area, i.e., in the north-east, east-west, north-south and north-west directions.

2. A spatial natural fracture grading and classification quantitative identifier is constructed by means of seismic attribute multi-level nested variable time window optimization.

On the basis of using the wellbore natural fracture grading and classification quantitative identifier, the spatial natural fracture grading and classification quantitative identifier is constructed by means of the seismic attribute multi-level nested variable time window optimization, thus achieving accurate and reliable identification of grading and classification characteristics of the natural fracture.

Firstly, with a seismic amplitude data volume as a main input, a structural smoothness variable time window optimization quantitative identifier for the optimum natural fracture suitability is constructed by optimizing the structural smooth filtering mode and the geometric size of the time window. Secondly, with the structural smoothness optimized by variable time window as the main input, the difference comparison of different filtering smoothness scale in different directions, dip angle correction in multiple directionals, plane confidence threshold setting and dip guided smoothing are carried out to establish a variance cube variable time window optimization quantitative identifier for improving the sensitivity of the natural fracture. Finally, with the variance cube optimized by the variable time window as a main input, a tracking pattern, a tracking element arrangement distance, tracking deviation parameters, an ant step size, an illegally allowable step size, a legally allowable step size and ant tracking stop criterion settings are optimized, and an ant-dynamic-tracking based natural fracture grading and classification quantitative identifier is constructed. By means of the sequential application of the above three natural fracture grading and classification quantitative identifiers, the multi-level nesting of seismic amplitude data volume-structural smoothness-variance cube-ant tracking is further implemented, and the spatial natural fracture grading and classification quantitative identifier is constructed, so as to achieve the grading and classification quantitative identification of the natural fracture by means of the seismic attribute multi-level nested variable time window optimization technology.

(1) A structural smoothness variable time optimization quantitative identifier for optimum natural fracture suitability is constructed.

Firstly, a seismic amplitude data volume is input. Then, filtering modes are compared to screen out a filtering mode with a maximum resolution and signal-to-noise ratio suitable for natural fracture characterization. Finally, the size of a filtering variable time window in different directions in a three-dimensional space is optimized to construct a structural smoothness variable time optimization quantitative identifier for optimum natural fracture suitability.

Aiming at a study area, the screened filtering modes are dip-angle guidance and edge enhancement, and the optimized filter variable time window size is 1, thus constructing a structural smoothness optimization quantitative identifier for the optimum natural fracture suitability.

(2) A variance cube variable time window optimization quantitative identifier for improving the sensitivity of the natural fracture is constructed.

A processing result of the structural smoothness variable time window optimization quantitative identifier for optimum natural fracture suitability is used as a main input, and difference between processing results in different directions and different filtering variable time windows is compared by means of optimization of filtering bandwidths of an inline and a crossline and optimization of a vertical smooth filtering variable window length, thus weakening stratum-along information. Dip angles of variance cubes in different directions are corrected by means of proportional optimization of variable time window in vertical direction, the inline, and the crossline, thus forming fracture structures with different occurrences. It is ensured that computation of variance along a dip-angle plane has real information coverage by means of optimization of a variable correction threshold of the dip-angle plane. The sensitivity of discontinuous structures is enhanced by means of structural characteristics such as smooth dip angle steering, and prominent faults and fractures. The variance cube variable time window optimization quantitative identifier for improving the sensitivity of the natural fracture is constructed by using the above technology.

For a study area, the finally formed planar filtering bandwidth is 3×3, the vertical smooth filtering window length is 25, a ratio of time window in vertical direction, the inline, and the crossline is 1.5×1.5×1.5, and a correction threshold of the dip-angle plane is 0.9. The variance cube variable time window optimization quantitative identifier is constructed, which improves the sensitivity of natural fracture prediction in this study area.

(3) An ant-dynamic-tracking based spatial natural fracture grading and classification quantitative identifier is constructed.

The variable time window optimization quantitative identifier is used to improve the sensitivity of the natural fracture. An established variance cube is used as a main input and an identification result of the wellbore natural fracture grading and classification quantitative identifier is used as a constraint to optimize ant tracking patterns, thus forming ant tracking patterns aiming at fracture information of different scales. An initial ant tracking range is optimized to form an initial ant tracking range capable of capturing more tracking traces. Ant tracking azimuth deviation is adjusted to form a maximum legal distance that the ant deviates when searching in different directions. An ant motion step size is optimized to form a maximum distance that the ant searches effectively forward. An illegally allowable step size is optimized to form an illegally allowable maximum search distance when no local abnormal point is found in the previous step, thus tracking as much abnormal information as possible. A legally allowable step size is optimized to establish a legally allowable step size with a maximum value on the basis of the implementation of the illegally allowable step size, thus achieving the connection, recording and output of real abnormal points. An ant tracking stop criterion is optimized, and an illegally allowable step size stop criterion is defined by comparing with the development characteristics and distribution range of the natural fracture, thus stopping illegal ant tracking process. By means of the implementation of the above seven optimization steps, an ant-dynamic-tracking based spatial natural fracture grading and classification quantitative identifier is constructed. By applying the quantitative identifier, firstly, the three-dimensional characterization of large faults is formed, then the small fractures are characterized synchronously, and at the same time. Meanwhile, the dynamic tracking of large faults and small fractures is implemented, and finally a time-domain natural fracture grading and classification prediction model is established.

The specific parameters of the constructed ant-dynamic-tracking based spatial natural fracture grading and classification quantitative identifier in a study area are as follows. The ant tracking pattern is a self-defined tracking pattern based on active tracking, the initial ant tracking range is 2, the tracking azimuth deviation is 2, the ant motion step size is 3, the illegally allowable step size is 2, the legally allowable step size is 2, and the illegally allowable step size stopping criterion is 10. On this basis, combining the fault interpretation results, the large faults and small fractures are characterized in turn, and the dynamic tracking of large faults and small fractures is achieved, and the time-domain natural fracture grading and classification prediction model is established.

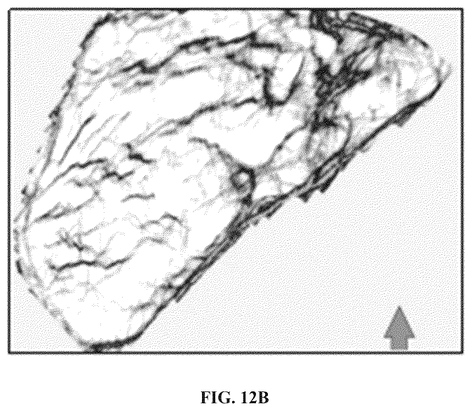

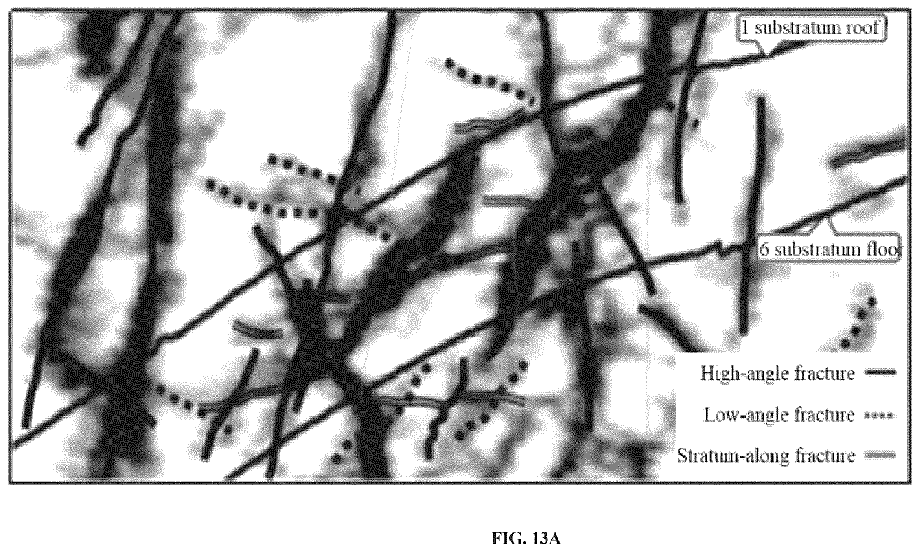

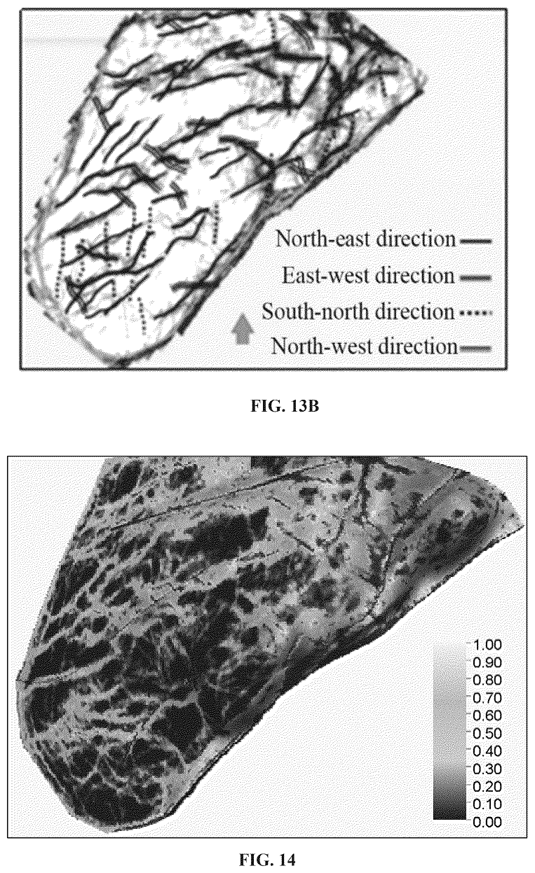

FIGS. 12A-12B are images of results of above technical methods. By using structural smoothness variable time window optimization technology, the maximum resolution and signal-to-noise ratio are achieved, thus providing appropriate seismic amplitude data volume for the characterization of the natural fracture. On this basis, the variance cube variable time window optimization technology is used to enhance the sensitivity of discontinuous structures such as faults and fractures. Furthermore, the ant dynamic tracking technology is combined to form the dynamic tracking process of large fault-small fracture and achieve the synchronous characterization of large fault-small fracture. By cutting a stratum-along slice and the longitudinal section of a target section on the time-domain natural fracture grading and classification prediction model (FIGS. 13A-13B), the grading distribution characteristics that the natural fractures show a stratum-along fracture, a low-angle fracture and a high-angle fracture in the longitudinal direction, and the classification distribution characteristics that the plane of the natural fractural is in north-east, east-west, north-south and north-west directions are found, thus achieving the graded and classified characterizations of the natural fracture based on the ant dynamic tracking.

3. A natural fracture three-dimensional network model is established using a grading and classification modeling method.

A depth-domain natural fracture distribution and development space prediction model is established through time-depth information conversion based on the spatial natural fracture grading and classification quantitative identifier constructed by means of seismic attribute multi-level nested variable time window optimization. The natural fracture grading and classification characteristic parameters are quantitatively picked up. Further, the grading and classification modeling method is used to establishing a natural fracture grading and classification onset index model for characterizing the space development range and a grading and classification natural fracture strength model for characterizing the space development density, finally completing the three-dimensional discrete network model for the grading and classification of the natural fracture.

(1) Natural fracture grading and classification characteristic parameters are quantitatively picked up.

The wellbore natural fracture grading and classification quantitative identifier and the spatial natural fracture grading and classification quantitative identifier are comprehensively utilized to obtain grading and classification features of the core and the wellbore fused with the natural fractures and optimization results of natural fracture variable time window and multi-level nested seismic attributes. The depth-domain natural fracture distribution and development space prediction model is established through time-depth information conversion, and the prediction model is normalized. Under the control constraints of the grading and classification characteristics of the natural fracture, by setting a grid value of a developed fracture to be 1 and a grid value of an undeveloped fracture to be 0, the normalized depth-domain natural fracture distribution and development space prediction model is transformed into a distribution planar graph of substratum natural fractures in different strata and systems. The natural fracture grading and classification onset index model is established using a facies-controlled modeling strategy. A natural fracture grading and classification development strength model is established with an amplitude value as the development density indication of the natural fracture (when the value is 0, there is basically no fracture, and with the increase of the value, the fracture develops more) and the natural fracture onset index models of the different systems as the constraint condition.

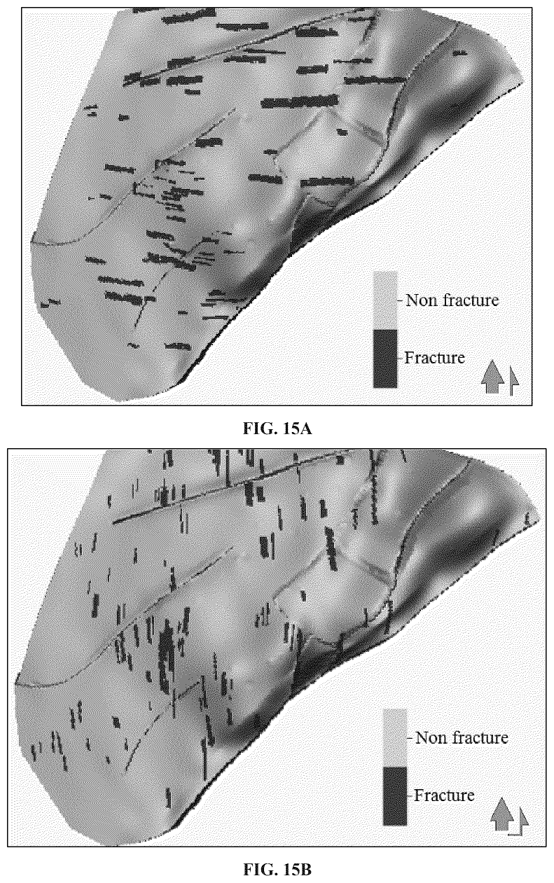

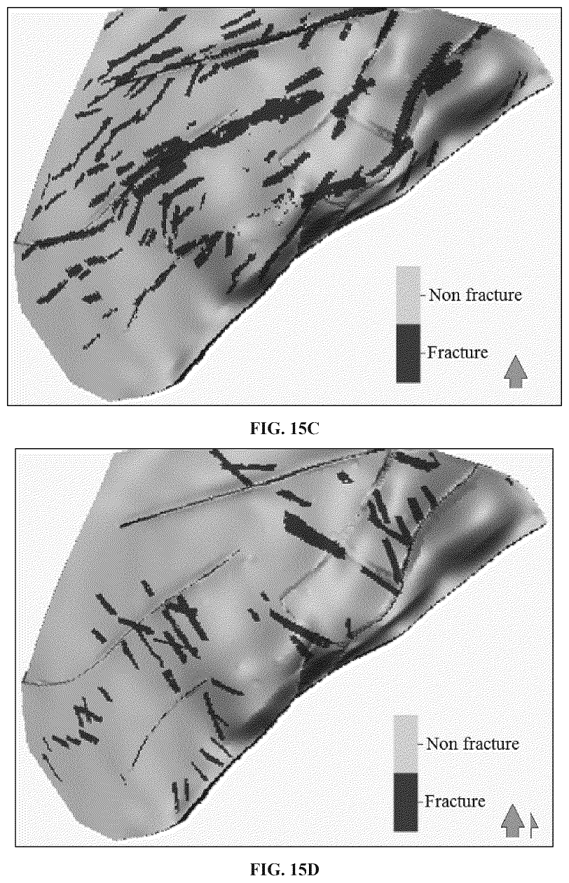

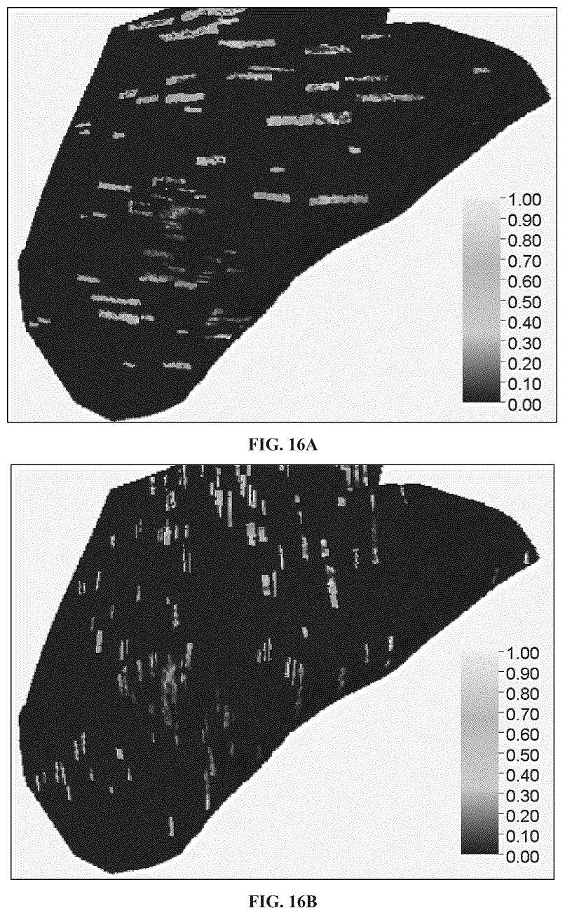

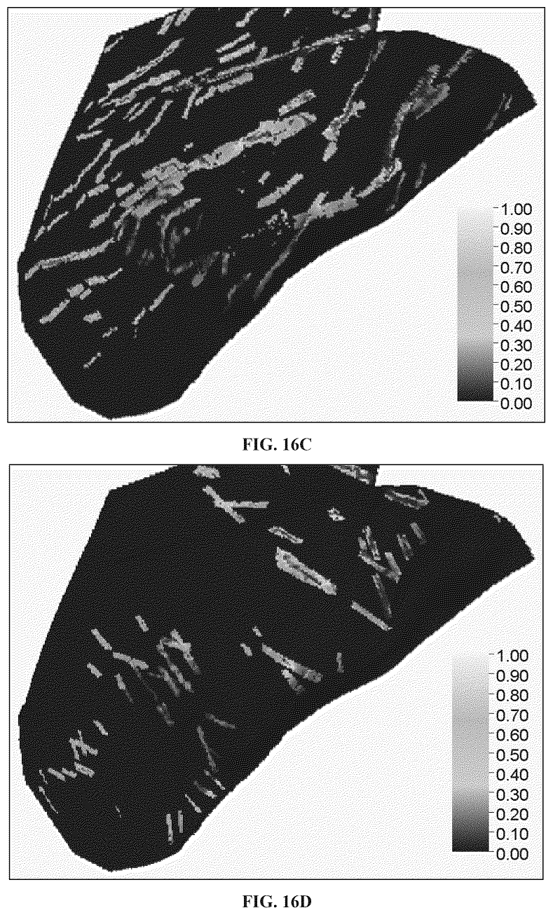

FIG. 14 is a natural fracture distribution and development space prediction model of an oilfield. The model firstly normalizes the natural fracture distribution and development space prediction model in the study area, making the value of the model distributed between 0 and 1. The natural fracture development space is restricted by the natural fracture grading and classification characteristic constraints, and planar distribution graphs of six substratum natural fractures in different strata and different systems are drawn, and the natural fracture grading and classification onset index model is established by facies modeling (FIGS. 15A-15D). Afterwards, constrained by the grading and classification onset index model, the grading and classification natural fracture development intensity model is established (FIGS. 16A-16D).

(2) A natural fracture three-dimensional network model is established using a grading and classification modeling method.

A natural fracture grading and classification three-dimensional discrete network model is formed with the grading and classification natural fracture onset index model as the spatial constraint of an interpolation of the natural fracture and the grading and classification natural fracture strength model as the main input. Based on this, the natural fracture three-dimensional network model is established to accurately reproduce the system characteristics of the natural fracture in the three-dimensional space, as well as the distribution position, azimuth, dip angle and shape of each fracture piece in each system, achieving the characterization and modeling of the natural fractures near faults and in structurally stable zones far away from the faults, and clearly depict the heterogeneity of spatial distribution and the complexity of development of the natural fractures.

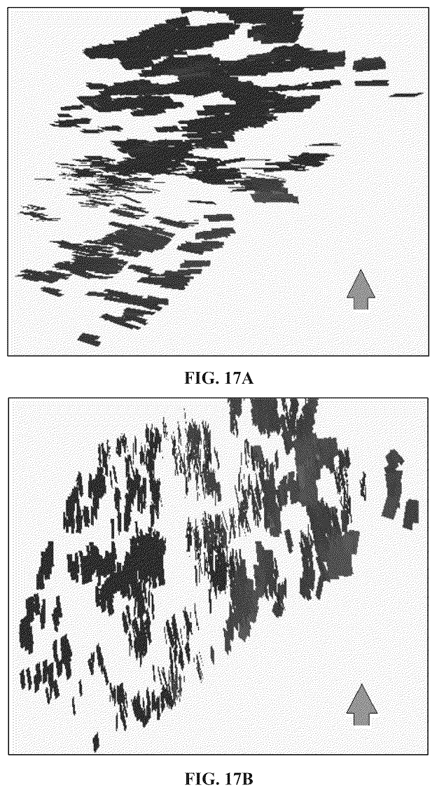

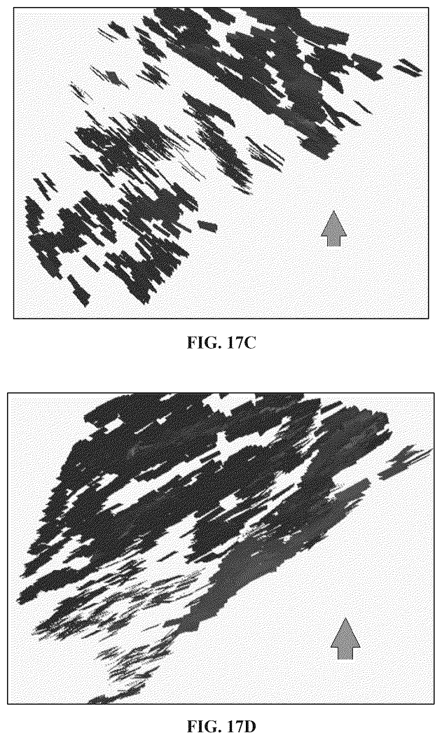

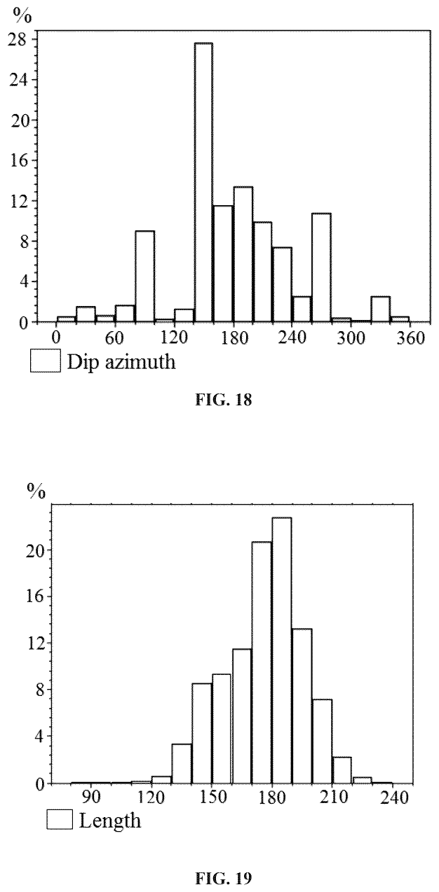

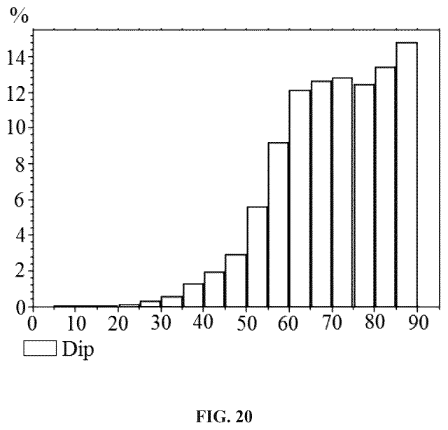

FIGS. 17A-17D are schematic diagrams of three-dimensional network models of the natural fracture in an oil reservoir established by the above method. In the zones near the fault and in the zone where the fault turns, the stress is concentrated, and the natural fracture is relatively more developed. There are four systems of natural fractures in the study area: east-west, north-south, north-west, and north-east, with southwest-northeast fractures accounting for a large proportion (FIG. 18). The lengths of the fractures are basically concentrated at about 200-300 m (FIG. 19), and there are high-angle fractures (60-90°), low-angle fractures (45-60°) and stratum-along fractures (0-45°) developed in the longitudinal direction, mainly high-angle fractures (FIG. 20), and thus, the construction of the grading and classification three-dimensional network model of the natural fracture is realized.

The scheme provided by the present disclosure includes a wellbore natural fracture grading and classification quantitative identifier, a spatial natural fracture grading and classification quantitative identifier, and a natural fracture grading and classification three-dimensional modeling method.

Firstly, by analyzing a dynamic evolution relationship between a stress field and lithofacies, natural fracture grading and classification characteristic patterns are established. On this basis, a natural fracture in-situ grading characteristic quantitative identifier is constructed by fusing microscopic and macroscopic information of a core. Further, a wellbore natural fracture grading and classification characteristic quantitative identifier is established by fusing static and dynamic information. By using the seismic attribute multi-level variable time window technology, a structural smoothness variable time window optimization quantitative identifier for optimum natural fracture suitability, a variance cube variable time window optimization quantitative identifier for improving sensitivity of the natural fracture, and an ant-dynamic-tracking based natural fracture grading and classification quantitative identifier are constructed, respectively. On the basis of an identification result of the natural fracture grading and classification quantitative identifier, the natural fracture grading and classification characteristic parameters are quantitatively picked up. Further, a grading and classification modeling method is adopted to complete accurate, reliable and rapid construction of the natural fracture grading and classification three-dimensional network model, thus achieving the precise and accurate description of the planar and longitudinal distribution characteristics and laws of the natural fracture.

The basic principle, main features and advantages of the present disclosure have been shown and described above. It should be understood by those skilled in the art that the present disclosure is not limited by the above embodiments, and the description in the above embodiments and the specification are only the illustration of the principle of the present disclosure. There will be various changes and improvements without departing from the spirit and scope of the present disclosure, all of which shall fall within the scope of protection of the present disclosure. The scope of the present disclosure is defined by the appended claim and their equivalents.

It should be noted that for the sake of simple description, all the above method embodiments are expressed as a series of action combinations, but those skilled in the art should know that the present disclosure is not limited by the described action sequence, because some steps can be performed in other sequences or at the same time according to the present disclosure. Secondly, those skilled in the art should also know that the embodiments described in the specification are all preferred embodiments, and the actions and units involved are not necessarily necessary for the present disclosure.

In the above embodiments, the description of each embodiment has its own emphasis. The parts that are not described in detail in an embodiment can refer to the relevant descriptions of other embodiments.

Those skilled in the art can understand that all or part of the processes in the method for implementing the above embodiment methods can be completed by instructing related hardware through a computer program, which can be stored in a computer-readable storage medium, and when executed, the program can include the processes of the above-mentioned embodiments. The storage medium may be a magnetic disk, an optical disk, a ROM (read-only memory), a RAM (random-access memory) and the like.

All the above are only the preferred embodiments of the present disclosure, which certainly should not be used to limit the scope of the present disclosure, so the equivalent changes made according to the claims of the present disclosure still fall within the scope of the present disclosure.

What is claimed is:

1. A modeling method for identifying a natural fracture using a grading and classification quantitative identifier, comprising:
constructing a wellbore natural fracture grading and classification quantitative identifier by means of fusion of static and dynamic information and macroscopic and microscopic information;
constructing a spatial natural fracture grading and classification quantitative identifier by means of seismic attribute multi-level nested variable time window optimization; and
establishing a natural fracture three-dimensional network model using a grading and classification modeling method.

2. The modeling method according to claim 1, wherein the constructing a wellbore natural fracture grading and classification quantitative identifier comprises:
analyzing a dynamic evolution relationship between a stress field and lithofacies to establish natural fracture grading and classification characteristic patterns;
constructing a natural fracture in-situ grading characteristic quantitative identifier by fusing microscopic and macroscopic information of a core; and
establishing the wellbore natural fracture grading and classification quantitative identifier by fusing the static and dynamic information;
wherein establishing the natural fracture grading and classification characteristic patterns comprises:
determining a grading characteristic pattern that the natural fracture shows a stratum-along fracture, a low-angle fracture, or a high-angle fracture in a longitudinal direction; and
determining a classification characteristic pattern that a natural fracture plane changes in different directions.

3. The modeling method according to claim 2, wherein the constructing a natural fracture in-situ grading characteristic quantitative identifier comprises:
establishing a stratum-along fracture, low-angle fracture and high-angle fracture characteristic identification pattern by fusing the microscopic and macroscopic information of the core based on the grading characteristic pattern and the classification characteristic pattern of the natural fracture;
establishing a stratum-along fracture, low-angle fracture and high-angle fracture characteristic quantitative identifier based on the stratum-along fracture, low-angle fracture and high-angle fracture characteristic identification pattern, which is a natural fracture grading characteristic quantitative identifier; and
constructing a natural fracture in-situ grading characteristic quantitative identifier by means of core proper-horizon restoration, and implementing in-situ characterization of the grading characteristic pattern of the natural fracture.

4. The modeling method according to claim 3, wherein the establishing the wellbore natural fracture grading and classification quantitative identifier comprises:
extracting response characteristics of static information of a graded fracture based on an in-situ characterization result of the natural fracture grading characteristic quantitative identifier, and establishing a natural fracture grading characteristic static logging information quantitative identifier;
wherein the response characteristics comprise a lithologic indication curve, a porosity indication curve, a resistivity indication curve, an array acoustic wave amplitude curve and an array acoustic wave anisotropy curve corresponding to each of the stratum-along fracture, the low-angle fracture, and the high-angle fracture;
verifying a degree of development of a natural fracture at a same wellbore position by fusing response characteristics of dynamic output information of the wellbore, and establishing a natural fracture grading characteristic dynamic output information quantitative identifier; and
establishing a wellbore natural fracture classification characteristic quantitative identifier by fusing the static and dynamic information;
wherein the establishing a wellbore natural fracture classification characteristic quantitative identifier comprises:
employing array acoustic anisotropic interpretation, geostress azimuth indication and dynamic changes in production, based on natural fractures at different depths in a longitudinal direction identified by the natural fracture grading characteristic quantitative identifier;
analyzing a planar azimuth change characteristic of a natural fracture in a depth-specific layer to form a static and dynamic quantitative identification for different systems of natural fractures in a same layer; and
establishing the wellbore natural fracture classification characteristic quantitative identifier.

5. The modeling method according to claim 4, wherein the constructing a spatial natural fracture grading and classification quantitative identifier comprises:
constructing a structural smoothness variable time window optimization quantitative identifier for optimum natural fracture suitability;
constructing a variance cube variable time window optimization quantitative identifier for improving sensitivity of the natural fracture; and
constructing an ant-dynamic-tracking based spatial fracture grading and classification quantitative identifier.

6. The modeling method according to claim 5, wherein the constructing a structural smoothness variable time window optimization quantitative identifier for optimum natural fracture suitability comprises:
inputting a seismic amplitude data volume;
comparing filtering modes to screen out a filtering mode with a maximum resolution and signal-to-noise ratio suitable for natural fracture characterization; and
optimizing size of a filtering time window in different directions in a three-dimensional space, and constructing the structural smoothness variable time optimization quantitative identifier for optimum natural fracture suitability;
the constructing a variance cube variable time window optimization quantitative identifier for improving sensitivity of the natural fracture further comprises:
setting a processing result of the structural smoothness variable time window optimization quantitative identifier for optimum natural fracture suitability as a main input, and comparing difference between processing results in different directions and for different filtering variable time windows by means of optimization of filtering bandwidths of a inline and a crossline and optimization of a vertical smooth filtering variable window length, thus weakening stratum-along information;
correcting dip angles of variance cubes in different directions by means of proportional optimization of variable time window in a vertical direction, the inline and the crossline, thus forming fracture structures with different occurrences;
ensuring that computation of variance along a dip-angle plane has real information coverage by means of optimization of a variable correction threshold of the dip-angle plane; and
enhancing sensitivity of discontinuous structures by means of structural characteristics comprising smooth dip angle steering, and prominent faults and fractures.

7. The modeling method according to claim 6, wherein during the constructing an ant-dynamic-tracking based spatial fracture grading and classification quantitative identifier, sensitivity of the natural fracture is improved using the variable time window optimization quantitative identifier, an established variance cube is used as a main input and an identification result of the wellbore natural fracture grading and classification quantitative identifier is used as a constraint to optimize ant tracking patterns, thus forming ant tracking patterns aiming at fracture information of different scales, which comprises:
optimizing an initial ant tracking range to form an initial ant tracking range capable of capturing more tracking traces;
adjusting ant tracking azimuth deviation to form a maximum legal distance at which the ant deviates upon searching in different directions;
optimizing an ant motion step size to form a maximum distance at which the ant searches effectively forward;
optimizing an illegally allowable step size to form an illegally allowable maximum search distance when no local abnormal point is found in a previous step, thus tracking abnormal information;
optimizing a legally allowable step size, establishing a legally allowable step size with a maximum value based on an implementation of the illegally allowable step size, thus achieving connection, recording and output of real abnormal points; and
optimizing an ant tracking stop criterion, and defining an illegally allowable step size stop criterion by comparing with development characteristics and distribution range of the natural fracture, thus stopping illegal ant tracking process.

8. The modeling method according to claim 7, wherein the establishing a natural fracture three-dimensional network model using a grading and classification modeling method comprises:
establishing a depth-domain natural fracture distribution and development space prediction model through time-depth information conversion based on the spatial natural fracture grading and classification quantitative identifier, normalizing the depth-domain natural fracture distribution and development space prediction model, and setting a grid value of a developed fracture to be 1, and a grid value of an undeveloped fracture to be 0;
quantitatively picking up natural fracture grading and classification feature parameters;
wherein the quantitatively picking up natural fracture grading and classification feature parameters comprises:
converting the normalized depth-domain natural fracture distribution and development space prediction model into a distribution planar graph of substratum natural fractures in different strata and systems;
establishing a natural fracture grading and classification onset index model using a facies-controlled modeling strategy; and
constructing a natural fracture grading and classification development strength model by setting an amplitude value as an indication of a development density of the natural fracture and onset index models of different systems of natural fractures as constraint conditions; and
establishing the natural fracture three-dimensional network model using the grading and classification modeling method;
the modeling method is modeling method for forming a natural fracture grading and classification three-dimensional discrete network model with the natural fracture grading and classification onset index model as a spatial constraint of an interpolation of the natural fracture and the natural fracture grading and classification development strength model as a main input.
